(19) United States
(12) Patent Application Publication
(10) Pub. No.: US 2008/0263604 A1
(43) Pub. Date: Oct. 23, 2008

(54) PERSONAL CONTENT ARCHIVE OPERABLE IN AN ELECTRONIC CONTENT ASSET PUBLICATION SYSTEM

(75) Inventors: Thomas J. Murray, Longmont, CO (US); David L. McGovern, Superior, CO (US)

Correspondence Address: PATTON BOGGS LLP, 1801 CALFORNIA STREET, SUITE 4900, DENVER, CO, 80202, US

(73) Assignee: YouBiquity, LLC, Superior, CO (US)

(21) Appl. No.: 12/058,434

(22) Filed: Mar. 28, 2008

Related U.S. Application Data
(60) Provisional application No. 60/912,735, filed on Apr. 19, 2007.
(60) Provisional application No. 60/953,527, filed on Aug. 2, 2007.
(60) Provisional application No. 60/953,996, filed on Aug. 4, 2007.
(60) Provisional application No. 60/953,995, filed on Aug. 4, 2007.

(51) Int. Cl. H04N 7/173

(52) U.S. Cl. 725/87

(57) ABSTRACT

The Electronic Content Asset Publication System operates as an overlay application on the native multi-media communication network to receive individual subscriber requests for a selected electronic content asset and deliver that asset to the requesting subscriber. This system acquires, stores, publishes, distributes, accesses and processes electronic content on demand and delivers this content in the format of the subscriber's communication device over a selected multi-media communications infrastructure. This system provides access to specific subscriber-initiated electronic content assets that are of interest to the subscriber. The electronic content assets comprise individual multi-media streams, multi-media files or streams of multi-media files, initiated and published by individual subscribers rather than the mass media distributed by conventional content sources.

### CROSS-REFERENCE TO RELATED APPLICATIONS

This application is a utility filing which claims priority to U.S. Provisional Application No. 60/912,735, filed Apr. 19, 2007 and tided “Video Content System”; U.S. Provisional Application No. 60/953,527, filed Aug. 2, 2007 and tided “Method And System For On-Demand Television Network”; U.S. Provisional Application No. 60/953,995, filed Aug. 4, 2007 and tided “Method And System For Electronic Retail Sales Of Video On Demand Assets”; and U.S. Provisional Application No. 60/953,996, filed Aug. 4, 2007 and tided “Method And System For Allocating Mass Storage For Video On Demand Assets”. This application also is related to the following U.S. patent applications filed on the same date as the present application: “Electronic Content Asset Publication System”, “System For Distributing Electronic Content Assets Over Communication Media Having Differing Characteristics”, “User Interface Architecture For An Electronic Content Asset Publication System”, and “System For Managing Distributed Assets In An Electronic Content Asset Publication System”.

### FIELD OF THE INVENTION

This invention relates to multi-media communication networks and to a system that is operable in these networks to uniquely identify electronic content assets and to provide ubiquitous access to selected electronic content assets by authorized requesters.

### BACKGROUND OF THE INVENTION

It is a problem in multi-media communication networks to efficiently serve subscribers by providing access to specific subscriber-initiated electronic content assets that are of interest to the subscriber. The electronic content assets comprise individual multi-media streams, multi-media files or streams of multi-media files, initiated, or selected, or published by individual subscribers rather than the programmed mass media distributed by conventional content sources.

There are a number of existing multi-media communication networks that serve to provide a subscriber with access to selected mass media content sources. These multi-media communication networks include the Public Switched Telephone Network PSTN), cellular communications systems, the Internet, Cable Television (CATV) systems, Satellite communication systems and the like. These various multi-media communication networks each provide a specific communication medium that is used to deliver mass media content to the subscriber from predetermined mass media content sources. These mass media content sources can be broadcast stations (such as cable television channels) that transmit a stream of multi-media files (programs) to subscribers or can be media repositories (such as a web site or a video on demand system) that deliver mass media content to the subscriber upon receipt of a request from the subscriber.

For example, traditional television network programming (including broadcast, cable, satellite, etc.) is presented according to a linear channel model, where the channel content and the broadcast schedule are immutable and are set by the television network. This model imposes content and temporal constraints on subscribers that give rise to the “nothing's on” syndrome. Despite ongoing efforts of television providers to serve more niches by increasing their linear channel lineups, expanding their video on demand libraries and offering time-shifting digital video recorders, the “nothing's on” syndrome persists and is symptomatic of an under-served market. Clearly, frustrated subscribers would enjoy more choices, personalized services and access to non-traditional creative content.

While many television providers presently offer hundreds of linear channels, the potential number of such channels is limited by technology, economics and customer satisfaction. By comparison, the number of available video content niches far outstrips the linear channel capacity of all current and future television networks, and the growth potential for professional and amateur video alike seems unbounded. As television providers seek to add ever more linear channels to satisfy emerging niche markets, eventually an unwieldy number of channels will saturate weary subscribers. By contrast, Internet video sites such as YouTube provide visitors with myriad content choices and on-demand viewing via a single, “non-linear” channel, i.e., the web browser. These sites are the antithesis of the linear channel model of television network programming, and these web sites are wildly popular with visitors, occasional copyright issues notwithstanding.

It is a problem in all of these systems to provide the subscribers with access to content of interest to the subscriber on an individual basis, via a communication medium that has sufficient bandwidth to deliver the content with the desired quality of service. Existing high bandwidth, linear channel model-based systems deliver blocks of program channels to the subscriber on a subscription basis, with the programs being transmitted at predetermined times so the subscriber can only select which of the plurality of concurrently transmitted channels is received by the subscriber's terminal device. Existing low bandwidth systems enable a subscriber to individualize their access to electronic content, but the range of available content is limited due to the lack of adequate bandwidth to efficiently deliver the content. Therefore, the subscriber is unable to obtain personalized and efficient access to both professional and amateur multi-media content on the respective transmission systems noted above.

There is no multi-media communication network that presently has the capability to provide the granularity of selection to the subscriber to enable the subscriber to have an individualized selection of content at a time, place and medium of their choice or to enable the subscriber to publish their own personally generated or personally acquired electronic content. This includes the inability of the subscriber to select an individualized suite of program channels as their service subscription as well as the individual selection of personal services and non-traditional content for immediate or subscriber-programmed delivery.

### BRIEF DESCRIPTION OF THE INVENTION

The above-described problems are solved and a technical advance achieved in the field by the present Personal Content Archive Operable In An Electronic Content Asset Publication System (termed “Electronic Content Asset Publication System” herein) which operates as an overlay application on existing multi-media communication networks to receive individual subscriber requests for a selected Electronic Content Asset and deliver that asset, at a desired time and place, to the requesting subscriber in a mode appropriate for the subscriber's communication device over the multi-media communication network that serves this communication device. The Electronic Content Asset Publication System is therefore substantially medium agnostic, enabling subscribers to request a selected Electronic Content Asset without the limitation of predetermined content transmission mediums, modes and times. The Electronic Content Asset Publication System also includes a registration system component which enables subscribers to publish their personally generated or personally acquired Electronic Content Assets and which also functions to authorize selected subscribers to access these assets, rather than being constrained to use an immutable schedule of programs.

The Electronic Content Asset Publication System addresses the “nothing's on” syndrome by rejecting the linear channel programming model and adopting a non-linear access model, such as that used for Internet video, with its high potential for personalization, to provide distribution of subscriber-selected Electronic Content Assets via a multi-media communication network. The Electronic Content Asset Publication System exploits the simple fact that most subscribers prefer to relax in front of the television set or alternative, TV-capable devices including cell phones, PDAs and computers. The Electronic Content Asset Publication System therefore provides a portal to existing multi-media communication networks and offers on-demand access to a vast array of artfully-indexed niche content which is sourced from all over the world, along with new personal services such as: online video purchasing, rental and storage; community television; social networking; videoconferencing; live and recorded video monitoring for homes and businesses; and personalized multi-media content sharing with friends and associates. In this way, the Electronic Content Asset Publication System creates a multitude of content choices, empowers subscribers and makes multi-media communication networks work for consumers on a very intimate level that present multi-media communication networks cannot achieve. The Electronic Content Asset Publication System is a true personalized service.

### BRIEF DESCRIPTION OF THE DRAWINGS

FIG. 1 illustrates, in block diagram form, the overall architecture of a multi-media communication network which implements a number of communication technologies, and which includes the present Electronic Content Asset Publication System;

FIGS. 2A and 2B illustrate, in block diagram form, a specific implementation of the present Electronic Content Asset Publication System in a multi-media communication network in a cable television environment;

FIG. 3 illustrates, in flow diagram form, the operation of the Electronic Content Asset Publication System in the publishing of an Electronic Content Asset;

FIG. 4 illustrates, in flow diagram form, a typical cable access protocol for Electronic Content Asset Publication System to retrieve an Electronic Content Asset;

FIGS. 5A and 5B illustrate, in flow diagram form, the operation of a typical Electronic Content Asset Publication System API which is used to create a stream for the requested Electronic Content Asset where the Publisher and Subscriber's Video Content Host Site operators are the same entities;

FIGS. 6A and 6B illustrate, in flow diagram form, the operation of a typical Electronic Content Asset Publication System API which is used to create a stream for the requested Electronic Content Asset where the Publisher and Subscriber's Video Content Host Site operators are different entities;

FIGS. 7A and 7B illustrate, in block diagram form, typical centralized and distributed Publisher/Subscriber database architectures where the database is shared among multiple operators;

FIG. 8 illustrates, in block diagram form, a single operator Video Content Host Site in a cable distribution network;

FIG. 9 illustrates, in block diagram form, the architecture of a single operator multi-site Video Content Host Site with two subscribers; and

FIG. 10 illustrates, in block diagram form, a multi-operator Video Content Host Site access arrangement.

### DETAILED DESCRIPTION OF THE INVENTION

The present Electronic Content Asset Publication System acquires, stores, publishes, distributes, accesses and processes Electronic Content Assets, on demand and over a multi-media communications infrastructure. The Electronic Content Asset Publication System for example, enables subscribers to digitally record multi-media content and to access live and recorded multi-media content for viewing on a conventional television set or a suitable Web-Enabled Device (WED), e.g., a personal computer, a PDA or a cell phone.

The Electronic Content Asset Publication System also provides the capability for the subscriber to permit others to access their personal live and recorded multi-media Electronic Content Assets on a television set or a WED device. Subscribers may access multi-media Electronic Content Assets for viewing at the same physical location where the Electronic Content Assets originate, or for viewing from a remote location, perhaps one situated at a great distance from the origin site.

Some applications include:
Social networking: The Electronic Content Asset Publication System supports on-demand multi-media public-access television comprising any number of social broadcast communities. Any or all social community members may simultaneously broadcast live or recorded Electronic Content Assets throughout their community. Each subscriber may belong to any number of such communities. Individual community members control community membership, content publication and content access.
Multiple-operator aggregate on-demand libraries: Television subscribers may access the on-demand libraries of multiple affiliated television operators.
Shared personal video libraries: Subscribers may import Electronic Content Assets from any compatible source such as camcorder home video, image files, audio files, text or graphic files, or a DVD movie. Subscribers may publish their imported Electronic Content Assets to other subscribers, pursuant to a set of subscriber-defined access permissions.
Wide-area time shifting: Subscribers located in one geographic region may record content as it is being distributed to that geographic region and may publish that recorded content to subscribers located in other geographic regions for viewing at any time before or after the same content is officially distributed to those geographic regions.

### Multi-Media Communication Network Examples

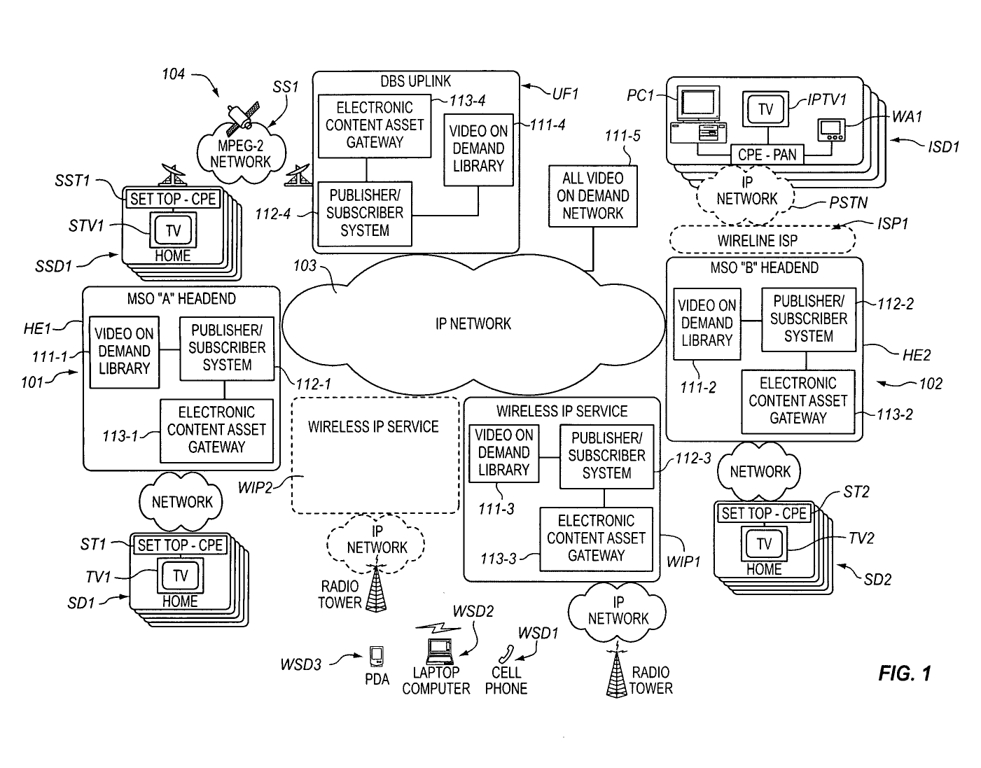

FIG. 1 illustrates, in block diagram, form the overall architecture of a multi-media communication network which implements a number of communication technologies, and which includes various elements of the present Electronic Content Asset Publication System. This view of multi-media communication networks is at a conceptual level, where the specific implementation details are omitted for the sake of clarity. A typical multi-media communication network comprises a plurality of physical elements to implement the communication mediums and associated signal distribution control systems. These functions are simply illustrated as the “Network” that interconnects and serves subscriber devices and asset sources. Note that today these networks are not interoperable for multi-media content distribution among all network nodes.

Examples of such multi-media communication networks include a Cable Television Network 101 and 102 that interconnects a plurality of subscriber devices SD1 and SD2, each comprising a television set TV1 and TV2 and its associated “set top box” ST1 and ST2, with the program source comprising a Master System Operator head-end HE1 and HE2 that receives program content from various sources and delivers the program content to subscribers via a plurality of concurrently broadcast channels. The Master System Operator head-end HE1 and HE2 is also shown as interconnected with the Internet 103. A Satellite Television Network 104 interconnects a plurality of subscriber devices SSD1, each comprising a television set STV1 and its associated “set top box” SST1, with the program source comprising a Master System Operator uplink facility UF1 that receives program content from various sources and delivers the program content to subscribers via a satellite system SS1 that transmits a plurality of concurrently broadcast channels. The Master System Operator uplink facility UF1 is also shown as interconnected with the Internet 103. Another multi-media communication network comprises a wire-line Internet Service Provider ISP1 that interconnects subscriber devices ISD1, such as personal computers PC1, IP Televisions IPTV1, other appliances WA1, with a program source via the Public Switched Telephone Network PSTN. The Internet Service Provider ISP1 may provide program content or simply interconnect the subscriber device with an entity, also served by the Internet 103, which contains the program content. A variation of the wire-line Internet Service Provider ISP1 is a wireless IP Service WIP1 and WIP2 that interconnects portable subscriber devices, WSD1-WSD3 such as cellular telephones WSD1, personal computers WSD2, PDAs, and WSD3 and the like, with a program source via the Cellular Telephone Network. The wireless IP Service Provider ISP1 and ISP2 may provide program content or simply interconnect the subscriber device with an entity, also served by the Internet 103, which contains the program content.

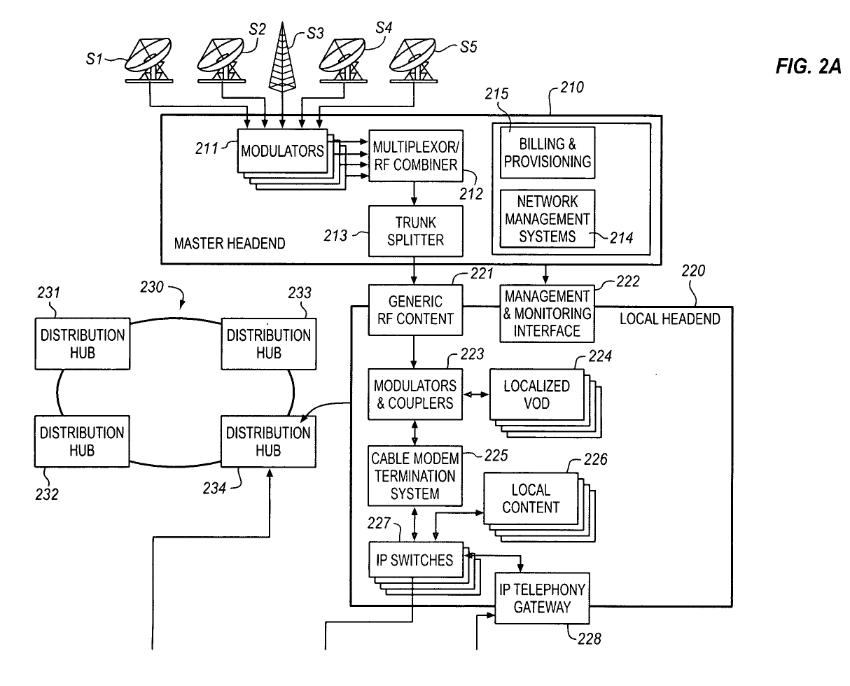

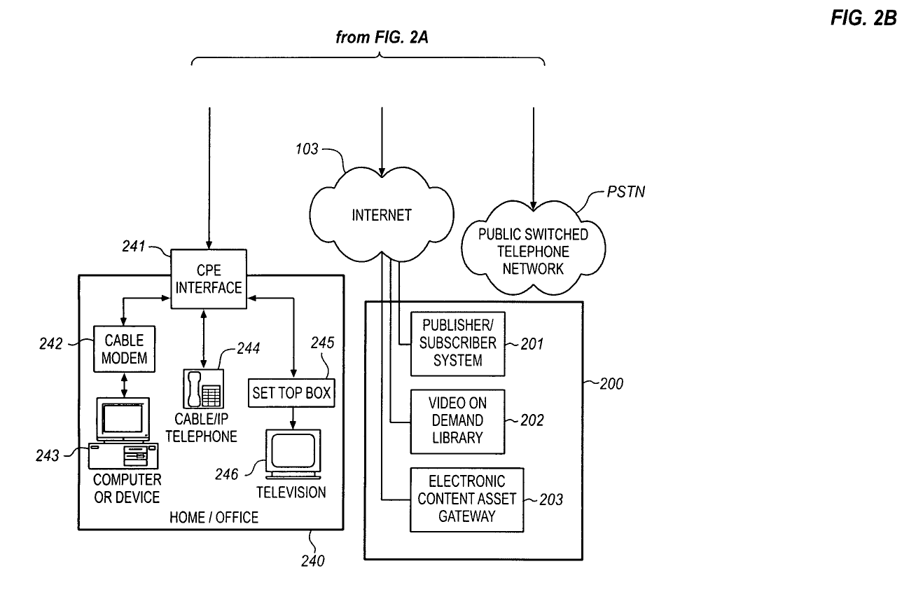

Connected to the multi-media communication networks, either directly or via the Internet 103, are a plurality of elements (typically distributed) that operate to implement the present Electronic Content Asset Publication System in a multi-media communication network. These elements include a Publisher/Subscriber System component 112-1 to 112-4 that functions to register published Electronic Content Assets. In addition, Publisher/Subscriber System component 112-1 to 112-4 uses the subscriber identity and Electronic Content Asset identifier to determine whether a subscriber is authorized to access an Electronic Content Asset, and to initiate delivery of that Electronic Content Asset to the subscriber via a multi-media communication medium, shown in additional detail in FIGS. 2A and 2B. The Publisher/Subscriber System component 112-1 to 112-4 may also include an entity that promotes a standardized method for rating content and establishing its appropriateness for particular classes of subscribers, and for authorizing or denying Electronic Content Asset access based on those ratings or classifications and the subscriber's class membership. Certain Electronic Content Assets are stored in various locations in this multi-media communication network and these are noted as Video on Demand Libraries 111-1 to 111-4, which are located in the various multi-media communication networks noted above. Certain other Electronic Content Assets such as live feeds or live streams are distributed within this multi-media communication network and might not be stored anywhere in this multi-media communication network. In addition, All Video On-Demand Network 111-5 is shown as connected to the Internet and functions to provide video on demand content and personalized subscriber services to the various multi-media communication networks noted above. Finally, Electronic Content Asset Gateway component 113-1 to 113-4 is shown and includes various multi-media communication network intercommunication and media translation functions as described below. These elements collectively operate with the existing multi-media communication networks and comprise the present Electronic Content Asset Publication System.

### Cable Television Network Embodiment

FIGS. 2A and 2B illustrate, in block diagram form, a specific implementation of the present Electronic Content Asset Publication System in a cable television environment. The example used here is equally applicable to any multi-media communication network and the operation of the present Electronic Content Asset Publication System in a multi-media communication network spans multiple types of multi-media communication networks without the limitation of predetermined content or predetermined content transmission mediums, modes and times. Thus, the underlying concept is the linking of a uniquely identified subscriber with a selected uniquely defined Electronic Content Asset. In the present example, the simple case of a subscriber creating a video stream and transmitting the video stream to a selected recipient is used to illustrate the underlying concepts of the present Electronic Content Asset Publication System in a multi-media communication network. As shown in FIGS. 2A and 2B, a typical Cable Television System includes a Master Head-End 210 that receives program content from multiple sources S1-S5, typically via satellite transmission or microwave transmission, and interconnects the received program content to a plurality of trunks that carry the program content in radio frequency format to multiple local head-end systems. The received radio frequency signals are modulated 211, multiplexed 212 and then split 213 into discrete channels. The program content is typically a continuous feed of individual programs broadcast on a predetermined time-of-day schedule and may include segments that are devoid of program content in order to enable the local head-end systems to insert their own local programming or local advertising. The operation of such a system is well-known in the art and is not described in detail herein and includes various administrative and program management elements, such as billing and provisioning 215 and network management systems 214.

Electronic Content Assets are available from a remotely located content server 200 which, as noted above, includes a Publisher/Subscriber System component 201 that functions to register published Electronic Content Assets. In addition, Publisher/Subscriber System component 201 uses the subscriber identity and Electronic Content Asset identifier to determine whether a subscriber is authorized to access an Electronic Content Asset, and to initiate delivery of that Electronic Content Asset to the subscriber via a multi-media communication medium. The Publisher/Subscriber System component 201 may also include an entity that promotes a standardized method for rating content and establishing its appropriateness for particular classes of subscribers, and for authorizing or denying Electronic Content Asset access based on those ratings or classifications and the subscriber's class membership. Certain Electronic Content Assets are stored in various locations in this multi-media communication network and these are noted as Video on Demand Libraries 202, which are located in the various multi-media communication networks noted above. Certain other Electronic Content Assets such as live feeds or live streams are distributed within this multi-media communication network and might not be stored anywhere in this multi media communication network. In addition, Electronic Content Asset Gateway component 203 is shown and includes various multi media communication network intercommunication and media translation functions.

The radio frequency program content, as received at the local head-end system 220, can be combined with a plurality of other content, such as: local content 226, video on demand 224, IP telephony 228, Internet data 227 and coupled to a distribution hub 234 which routes the signals from the local head-end system 220 to a plurality of local cable loops 234, comprising coaxial cable or fiber optic cable, and optionally also to other distribution hubs 231-233 and their plurality of local cable loops, comprising coaxial cable or fiber optic cable. The local loops terminate at a subscriber premises 240 at a cable interface 241 where the received signals are interconnected with one or more subscriber devices, such as: a set top box 245 and its associated television 246, cable modem 242 and its associated personal computer 243, cable/IP telephone 244, and the like. The communication path between the subscriber devices 242-246 located at the subscriber premises 240 and the local head-end system 220 is bi-directional, with the predominant portion of the available bandwidth being used in the downlink direction to the subscriber device 242-246 from the local head-end system 220.

### Terminal Equipment And Digital Video Content Recorders

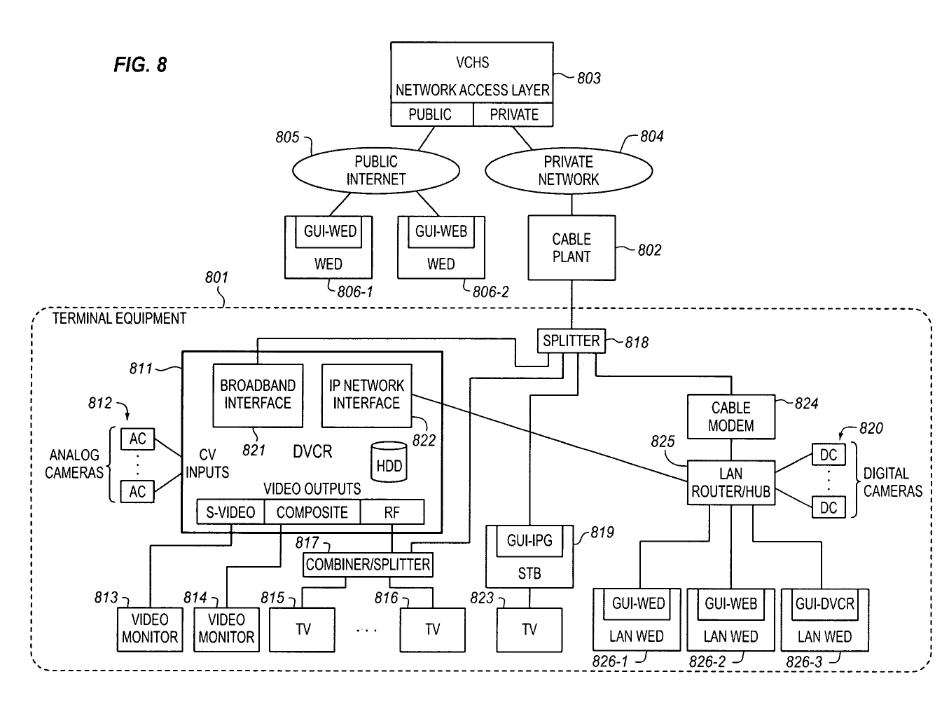

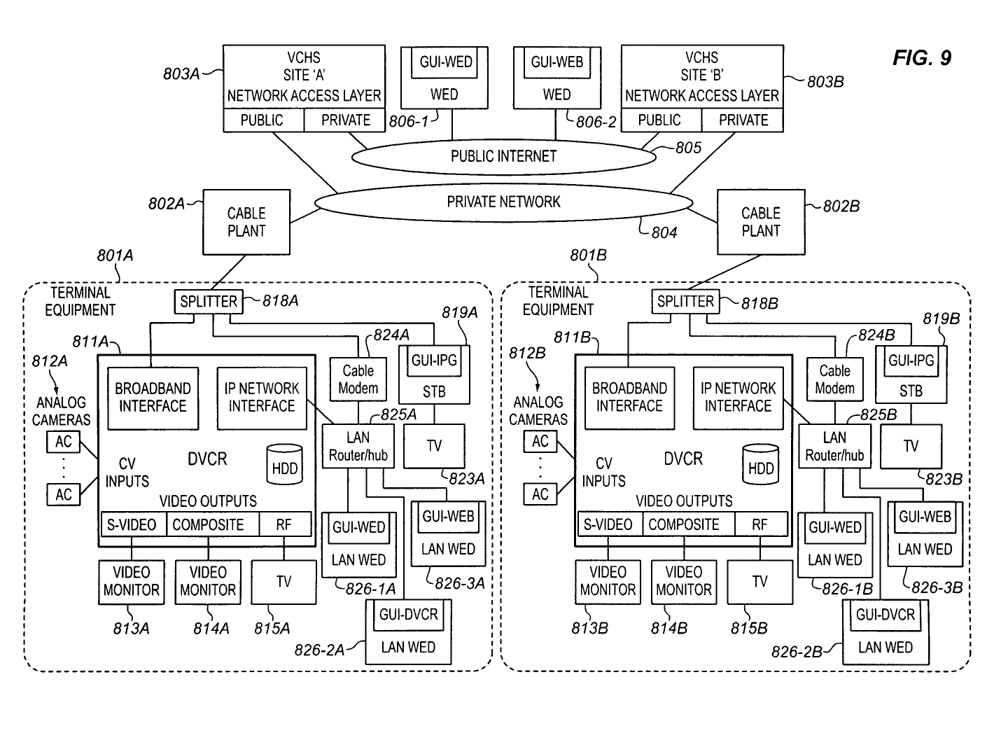

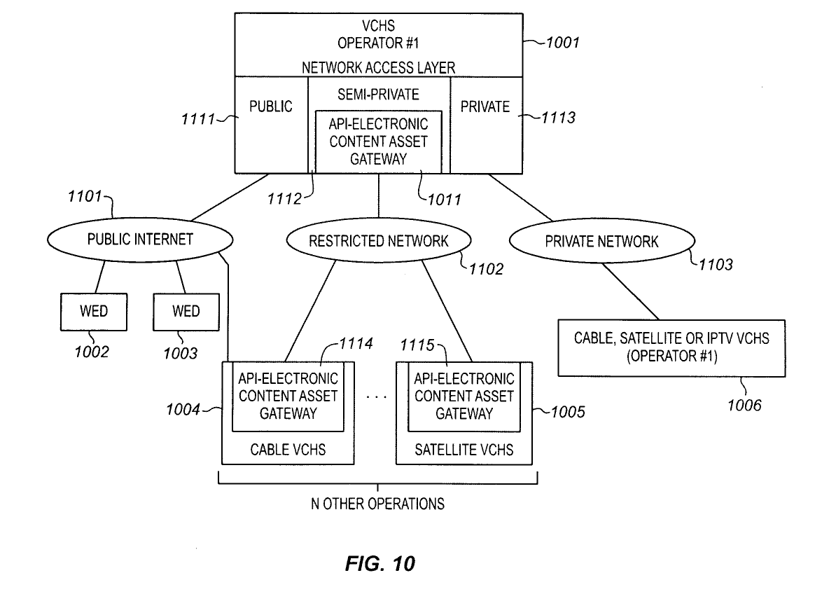

FIG. 8 illustrates, in block diagram form, a single operator Video Content Host Site in a cable distribution network and FIG. 9 illustrates, in block diagram form, the architecture of a single operator multi-site Video Content Host Site with two subscribers. These two configurations are described to illustrate some of the details of Electronic Content Asset delivery to individual subscribers. In FIG. 8, a single subscriber terminal equipment 801 is connected to a cable network 802 which uses a private network 804 to access Video Content Host Site 803. In addition, terminal equipment 806-1 and 806-2 can access Video Content Host Site 803 via Public Internet 805. The Terminal Equipment 801 is shown as being equipped with a multitude of devices, although in a typical installation, the number of devices is less than that shown in FIG. 8. The Terminal Equipment 801 includes a Digital Video Content Recorder 811 which serves Video Monitors 813 and 814 and televisions 815 and 816 via combiner/splitter 817. A splitter 818 is used to share the connection to the cable network 802 among Digital Video Content Recorder 811, television 823, combiner/splitter 817, and cable modem 824. The cable modem 824 interconnects the digital signals received from the cable network 802 with a Local Area Network 825 for distribution to selected ones of Web-Enabled Devices 826-1 to 826-3 and digital cameras 820. In FIG. 9, two terminal equipment 801A and 801B interconnect as shown in FIG. 8, with the Video Content Host Site 803A and 803B being implemented in two pieces.

### Digital Video Content Recorder (DVCR)

One component that can be used in the present Electronic Content Asset Publication System is the Digital Video Content Recorder (DVCR) which combines and extends the hardware and software functionality of present-day Digital Video Recorders and Network Video Recorders to interface various media input and output devices to the network. The Digital Video Content Recorder accommodates analog and network digital video cameras in combination; Digital Video Recorders only accept analog cameras, and Network Video Recorders only accept network digital cameras. The Digital Video Content Recorder incorporates video capture cards for analog camera inputs just as a DVR does; these devices perform analog-to-digital conversion of the analog camera feeds. The Digital Video Content Recorder also incorporates application software that simultaneously records video from the analog cameras and network-attached digital cameras. Digital Video Content Recorder hardware and software elements are illustrated in FIGS. 8 and 9. Hardware elements are interconnected via a high-speed digital bus. Persistent storage elements may include flash memory (or equivalent) or internal hard disk storage. The Digital Video Content Recorder may be configured without a hard disk if local recording is not required and may be configured without analog video inputs if only networked digital cameras are used.

Digital Video Content Recorder software elements include a network operating system with a secure IP-based network stack and device drivers for all installed system peripherals; Digital Video Content Recorder core software which provides recording, playback and streaming, Electronic Content Asset ingest, upload, transfer, archive and backup/restore functions, recording scheduler and recording schedule, Personal Video Archive storage allocation and management, system configuration and user administration, Electronic Content Asset creation and publication, video processing applications and video analytics applications, video metadata collection and recording, subscriber event, alert and notification systems, etc.; API-Video Content Host Site client software; API-Digital Video Content Recorder command server for controlling Digital Video Content Recorder core software functions; a subscriber graphical interface implementation for the Digital Video Content Recorder (GUI-DVCR); and optionally any suitable data-over-cable broadband support. Digital Video Content Recorder software resides in one or more Digital Video Content Recorder persistent storage elements. The Digital Video Content Recorder unit need not contain any exterior controls, e.g., switches, buttons, indicators or display panels; it may contain a power switch or a pilot light. The Digital Video Content Recorder may contain a subscriber-accessible CD-ROM or DVD tray. External connections may include input or output connectors for analog composite video signals or analog component video signals (CV connectors); optional audio input connectors for some or all of the analog video inputs; USB ports; electrical power connection; IP network port; S-video output connector(s); RF-modulated CATV output connector; broadband cable connector; and other media or peripheral device input or output connectors.

Digital Video Content Recorder configuration and operation is performed over the network via any Electronic Content Asset Publication System subscriber graphical interface or via any API-Digital Video Content Recorder client software for controlling a Digital Video Content Recorder by issuing API-Digital Video Content Recorder commands to a Digital Video Content Recorder. A Digital Video Content Recorder interoperates with Network Video Content Recorders, Video Content Host Site applications or other Digital Video Content Recorders via the API-Digital Video Content Recorder or via the API-Video Content Host Site. The Digital Video Content Recorder optional broadband network interface contains an internal cable modem and may support the CableLabs® DOCSIS® specification or any suitable broadband cable industry standard for two-way IP transmissions and streaming video transmissions. The Digital Video Content Recorder may stream live or recorded Electronic Content Assets over the broadband interface to the cable operator or Video Content Host Site operator for storage, distribution, access or processing. Streaming imposes very high upstream transmission requirements compared to the typical downstream-biased Internet subscriber. A cable operator could choose to cap the Digital Video Content Recorder broadband interface at a higher upstream rate compared to a standalone cable modem cap, to better support streaming video bandwidth requirements.

The Digital Video Content Recorder may also incorporate a separate IP-based network interface, which may be an Ethernet interface, to stream live or recorded Electronic Content Assets to a cable, satellite, IP Television (IPTV) or Video Content Host Site operator for storage, distribution, access or processing. This interface may be used in place of, or in conjunction with, the Digital Video Content Recorder broadband interface. As with the broadband interface, the Digital Video Content Recorder may deliver Electronic Content Assets over the IP network interface, including streaming transmissions for Content On-Demand access. If a Digital Video Content Recorder contains both a broadband interface and an IP-based interface, the Digital Video Content Recorder network operating system must be properly configured to route network traffic over these two interfaces. Each interface must be assigned a unique network address. The broadband interface may acquire its network address from the cable operator, and the Digital Video Content Recorder administrator may define a static or dynamic IP address for the IP network interface.

The essence of the Digital Video Content Recorder is the ability to accept analog and digital video cameras in combination; the ability to perform a variety of software functions in parallel with continuous recording, including API-Digital Video Content Recorder and GUI-DVCR local and remote functions; support for Content On-Demand and the Publisher/Subscriber model; support for local Personal Video Archives and local Video on Demand Libraries; the ability to import compatible Electronic Content Assets for storage in Personal Video Archives from sources including network uploads, CD-ROM media and DVD media; the ability to stream Electronic Content Assets for remote storage, access, distribution or processing; the ability to produce RF-modulated CATV video output; the ability to specify stream transmission rates for all local and remote functions; the ability to interoperate with a Video Content Host Site or any Electronic Content Asset Publication System subscriber graphical interface; an embedded web server implementing the web-based GUI-DVCR; and the ability to provide all of these functions and other functions in combination within a single Digital Video Content Recorder system.

Further, Digital Video Content Recorder implementations may vary in form or content in accordance with particular requirements, for example: one or multiple CPUs; zero or more hard disk drives; an open source network operating system versus a commercial real-time network operating system; more or less physical RAM memory; support for DOCSIS® or other suitable data-over-cable specification, and so on.

### Electronic Content Assets

An Electronic Content Asset is any multi-media machine-readable digital content such as a live or recorded video stream, live or recorded audio stream, image file, text file, graphics file, DVD movie, metadata or any other source of content. An Electronic Content Asset may also be composed, in a nested fashion or recursively or otherwise, of other Electronic Content Assets. The creator of an Electronic Content Asset may assign an Asset Identifier to the Electronic Content Asset which is a unique identifier that may reside within an associated Electronic Content Asset multi-media stream, file or metadata. Identical copies of an Electronic Content Asset multi-media stream or file may bear identical Asset Identifiers. The collection of Electronic Content Assets held by an Electronic Content Asset Publication System subscriber at a Video Content Host Site or a Digital Content Video Recorder, along with the collection of all other Electronic Content Assets published to that subscriber by other subscribers, is called a Personal Video Archive (PVA), as is the union of all Personal Video Archives held by an individual Electronic Content Asset Publication System subscriber at all Video Content Host Sites and all Digital Video Content Recorders comprising the present Electronic Content Asset Publication System.

### Publisher/Subscriber (P/S) Model

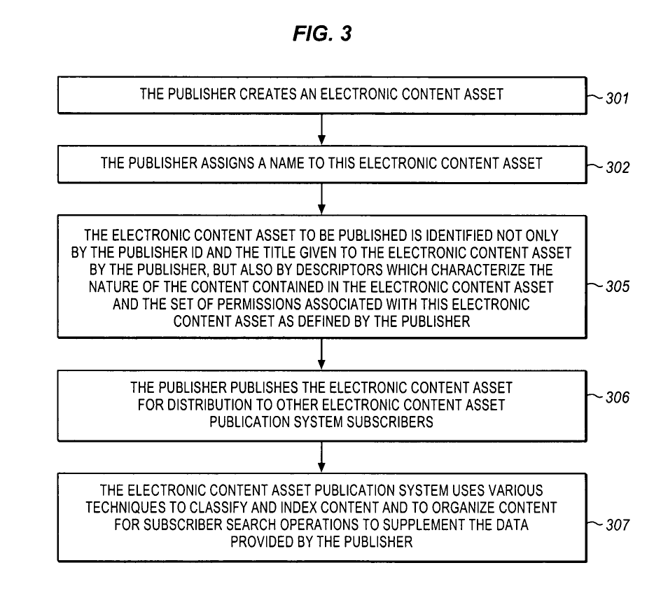

FIG. 3 illustrates, in flow diagram form, the operation of the Electronic Content Asset Publication System in the publishing of an Electronic Content Asset. In order to understand the ubiquity and diversity of the Electronic Content Assets and their management, a Publisher/Subscriber (P/S) model is used to define the Content On-Demand content ubiquity aspect of the Electronic Content Asset Publication System. The Publisher/Subscriber model logically provides a virtual multi-media canvas upon which a subscriber, who is called a Publisher, may prepare or compose an Electronic Content Asset for publication. Such Electronic Content Asset preparation or composition processes may specify a layout format which may be a tiled format, picture-in-picture format or any other format, and which may indicate the layout format in which the Electronic Content Asset should be rendered for viewing on a subscriber multi-media device. The example used herein to illustrate this concept is the creation of an Electronic Content Asset from one or more live or recorded camera feeds (each feed is one or several camera feeds combined as one feed) and/or Electronic Content Asset Metadata sources as defined below. The Publisher creates this Electronic Content Asset at step 301, assigns a name to this Electronic Content Asset at step 302 and publishes the Electronic Content Asset for distribution to other Electronic Content Asset Publication System subscribers at step 306, who are called Authorized Subscribers. The Publisher/Subscriber system at step 305 may assign descriptors that indicate a content rating for the published Electronic Content Asset or the appropriateness for access by particular classes of subscribers. The Publisher/Subscriber system may subsequently authorize or deny Electronic Content Asset access based on these ratings or classifications and the subscriber's class membership. An Authorized Subscriber may access an Electronic Content Asset on demand, in accordance with the terms of publication associated with this Electronic Content Asset. The Electronic Content Asset Publication System logically publishes each such created Electronic Content Asset to the Electronic Content Asset's own Publisher with no restrictions on its use; hence the Publisher/Subscriber model logically applies uniformly to all Electronic Content Assets within the present Electronic Content Asset Publication System. The Publisher of an Electronic Content Asset may update any characteristics of the published Electronic Content Asset at any time.

A Publisher may use Electronic Content Asset Publication System interactive design tools or layout tools to specify the composition, layout or format of one or more Electronic Content Assets comprising a new Electronic Content Asset including the placement or location of individual Electronic Content Assets upon the virtual layout canvas; or to specify the Electronic Content Assets to be used as backgrounds, wallpapers, borders, window frames, colors, fonts, graphics, icons; or to specify any other layout or design elements or resources, etc. An Electronic Content Asset composition or layout may also specify interactive features, renderings, animations, etc. For example, a Publisher may compose an Electronic Content Asset that is a collection of other Electronic Content Assets that are digital image files; next, the Publisher may layout this composed Electronic Content Asset in a window placed at a particular location on the virtual canvas and may specify the Electronic Content Asset shall be rendered or animated for viewing as a cyclic linear progression of its individual underlying Electronic Content Asset digital image files. Electronic Content Asset composition and layout data or metadata specified by the Publisher is stored in Publisher/Subscriber database entries describing the published Electronic Content Asset. Electronic Content Asset composition data or metadata may include the name or address of each multi-media stream or file comprising a published Electronic Content Asset. For example, Electronic Content Asset composition data or metadata may indicate the multi-media network address of a live stream, or the name and multi-media network address of a Video on Demand Library along with the name of a multi-media file stored in that Video on Demand Library.

The Publisher/Subscriber model defines a secure one-to-many subscription relationship that limits access to each Electronic Content Asset to a specified Authorized Subscriber base. Further, the publication process establishes a set of publication terms-of-use that may include, but are not limited to, re-publication rights, scheduled availability, medium access rights, device access rights, and so on. Re-publication terms-of-use establish whether or not an Authorized Subscriber has the right to re-publish an Electronic Content Asset to other Authorized Subscribers, with optional limits on the breadth and depth of the re-publication privilege for the Electronic Content Asset. Schedule terms-of-use allow the Publisher to specify when an Electronic Content Asset may be accessed, including, but not limited to, start date/time and duration, expiration date/time, recurrence frequency, and so on. Medium access rights terms-of-use define the multi-media communication medium(s) from which a published Electronic Content Asset may be accessed, e.g., the public Internet, cable television network, wireless network and any other multi-media communication mediums. Device access rights terms-of-use define the multi-media device(s) from which a published Electronic Content Asset may be viewed, e.g., cell phones, PDAs, Personal Computers, cable TVs, satellite TVs, IPTV and any other multi-media devices. A Publisher may selectively revoke subscription rights to a selected Electronic Content Asset at any time. The revocation of subscription rights may recursively expunge all re-published instances of the selected Electronic Content Asset. An Authorized Subscriber may unsubscribe from an Electronic Content Asset at any time.

Re-publication relationships may be private, semi-private or public. A private republication relation limits Electronic Content Asset access to the Authorized Subscribers who are assigned subscription rights firsthand by the Publisher, i.e., all re-publication rights to the Electronic Content Asset are disallowed. A semi-private re-publication relation limits re-publication capabilities, for example by allowing each firsthand Authorized Subscriber to optionally re-publish the Electronic Content Asset to only one other Authorized Subscriber. A public re-publication relation grants access to the Electronic Content Asset to every subscriber. All publication terms-of-use may apply to all three re-publication relations including schedule terms-of-use, medium access rights terms-of-use and device access rights terms-of-use.

### Subscriber Unambiguous Identity Credentials

Every subscriber including every Publisher and every Authorized Subscriber must have an unambiguous identity within the present Electronic Content Asset Publication System. The present Electronic Content Asset Publication System may use an identity-agnostic scheme for authenticating subscriber unambiguous identity credentials, for example a scheme where subscriber unambiguous identity credentials are issued and authenticated by one or more Video Content Host Site operators or by other entities operating beyond the present Electronic Content Asset Publication System; other forms of subscriber unambiguous identity credentials are possible. An illustrative example used herein of a subscriber unambiguous identity credential is a fully-qualified E-mail address of the form “username domainname” together with the password for that E-mail account, both of which are registered with one of the Video Content Host Site operators within the present Electronic Content Asset Publication System. If a subscriber has unambiguous identity credentials registered with more than one Video Content Host Site operator in an Electronic Content Asset Publication System or registered with more than one other entity operating beyond the present Electronic Content Asset Publication System, the subscriber is said to have unambiguous identity aliases, and each such alias unambiguously identifies the subscriber within the present Electronic Content Asset Publication System. A Publisher publishes an Electronic Content Asset by specifying the unambiguous identities and any unambiguous identity aliases of one or more Authorized Subscribers who may access that Electronic Content Asset. In the illustrative example used herein, the Publisher specifies one or more fully-qualified E-mail addresses for each Authorized Subscriber permitted to access a published Electronic Content Asset. The unambiguous identities and unambiguous identity aliases specified by a Publisher are stored in Publisher/Subscriber database Authorized Subscriber entries describing the published Electronic Content Asset and are known collectively as the Authorized Subscriber List for that Electronic Content Asset.

An Authorized Subscriber must present an unambiguous identity or an unambiguous identity alias as identity credentials for accessing an Electronic Content Asset. For Electronic Content Asset access from a WED device, an Authorized Subscriber uses GUI-WED or GUI-WEB to sign on from a WED device and then declare an unambiguous identity or any unambiguous identity aliases to be used for accessing Electronic Content Assets during that sign-on session. Video Content Host Site identity credential authentication software should authenticate these identity credentials before the Authorized Subscriber may use these identity credentials to access any Electronic Content Assets. Video Content Host Site identity credential authentication software may, for example, require an Authorized Subscriber to enter the password for each fully-qualified E-mail address listed as an unambiguous identity or unambiguous identity alias, and Video Content Host Site identity credential authentication software may contact the “domainname” site specified as a part of each E-mail address to verify that the given password for “username domainname” is a valid password. Other forms of Authorized Subscriber identity credential authentication are possible.

For Electronic Content Asset access from a cable television set, an Authorized Subscriber presents unambiguous identity or unambiguous identity alias credentials to the cable operator which is functioning as a Video Content Host Site operator. The cable operator may establish a default Authorized Subscriber unambiguous identity by matching the serial number or other unique data obtained from the Authorized Subscriber's set top box or equivalent cable receiver device with the Authorized Subscriber's cable account information held on file. An Authorized Subscriber may supply any unambiguous identity or unambiguous identity aliases via an Electronic Content Asset Publication System interactive program guide menu or screen, which may be a GUI-IPG menu or screen. An Authorized Subscriber may also “sign off” of the Electronic Content Asset Publication System from a cable television set so that another Authorized Subscriber may sign on from the same cable television set to supply his or her own unambiguous identity credentials. Electronic Content Asset Publication System identity credential authentication software hosted by the cable operator which is functioning as a Video Content Host Site operator should authenticate all Authorized Subscriber identity credentials before the Authorized Subscriber may use those identity credentials to access any Electronic Content Assets. The cable operator's identity credential authentication method may be the same method described herein to authenticate Authorized Subscriber identity credentials for Electronic Content Asset access from a WED device. An Authorized Subscriber may similarly sign on to the Electronic Content Asset Publication System from an IPTV television set or a satellite television set and may then supply their unambiguous identity credentials.

Video Content Host Site applications may use authenticated Authorized Subscriber identity credentials to retrieve a list of Electronic Content Assets published to the Authorized Subscriber, by querying one or more Publisher/Subscriber databases for all Electronic Content Assets published to each authenticated unambiguous identity or each authenticated unambiguous identity alias specified by this Authorized Subscriber. An Authorized Subscriber may access any Electronic Content Asset that is published to any of his or her authenticated unambiguous identity credentials, subject to any publication terms-of-use conditions specified by the Publisher or imposed by the present Electronic Content Asset Publication System.

### Electronic Content Asset Publication System Definitions

In order to illustrate the operation of the present Electronic Content Asset Publication System, the example of video content is used as a typical form of an Electronic Content Asset that is created and managed by this system. Hence the following description is video-centric, but this is not intended to limit the scope of the appended claims. In the creation and publication of Electronic Content Assets, the term Electronic Content Asset Metadata is used to describe the analog or digital information which describes certain characteristics of an associated Electronic Content Asset, or certain aspects of the physical, logical or operational systems located in the present Electronic Content Asset Publication System which is storing, distributing or processing the associated Electronic Content Asset. The physical location where the Electronic Content Asset Metadata originates is called the origin site, which is not necessarily a site where video cameras are located or where Electronic Content Assets are acquired, created, composed, processed, distributed or stored. Examples of Electronic Content Asset Metadata include, but are not limited to, a directory or index of stored Electronic Content Assets; a digital computer database record noting a change in a scene of a live video content observed by a video camera, such as the presence of a moving object within the scene or a change in lighting conditions at the scene; a digital computer message announcing that a particular video camera has failed, including the physical location of the camera and the time of the failure; a digital computer message that a particular Authorized Subscriber has accessed live video from a particular destination site; a digital computer database record indicating that a particular Authorized Subscriber accessed recorded video of a particular camera feed spanning a specified time period; and so on.

### Video Content Host Site (VCHS)

A Video Content Host Site (VCHS) is any data center that hosts the Electronic Content Asset Publication System elements located at that particular site. Such a data center may also host other applications not related to the present Electronic Content Asset Publication System. A single Video Content Host Site implementation may span all or part of a networked data center. If the Video Content Host Site facility spans multiple physical locations, the individual sites may or may not be co-located within the same geographic locale. The Video Content Host Site managing entity is called a Video Content Host Site operator. A cable, satellite or IPTV operator, or an Internet service provider or an online multi-media mass storage provider may be a Video Content Host Site operator. A cable, satellite or IPTV head-end or super head-end system, or an Internet service provider or an online multi-media mass storage provider may function as a Video Content Host Site. A particular Video Content Host Site operator may own or operate multiple Video Content Host Sites.

Video Content Host Site network traffic may traverse the Video Content Host Site logical or physical Network Access Layer (NAL), which is a portal for Video Content Host Site multi-media communication network access. Network Access Layer services include public, semi-private and private network access. Public access includes public Internet access. Semi-private access includes inter-operator access, possibly via the Electronic Content Asset Gateway as described below. Private access may be limited to intra-operator access. The Network Access Layer may implement Electronic Content Asset Gateway data interchange facilities, e.g., protocol converters, transcoders, encoders & decoders, modulators & demodulators, multiplexers & demultiplexers, etc. Electronic Content Asset Publication System subscriber accounts may be hosted at a Video Content Host Site and may be stored in a computer database system. Subscriber account information may include, but is not limited to, the typical communications account data: subscriber name, billing address, phone number, E-mail address, and account payment information; Electronic Content Asset Publication System subscriber login name and password; list of Electronic Content Asset Publication System services to which the subscriber is authorized; subscriber's home Video Content Host Site; network location of the subscriber's Digital Video Content Recorders, Network Video Content Recorders, or streaming media servers or applications; metadata describing the subscriber's personal Electronic Content Assets stored at this Video Content Host Site; Electronic Content Asset storage and security policies; mass storage quota; configuration change history; security certificates; video processing results such as reports, charts, graphs, spreadsheets and data files; and so on.

Video Content Host Site mass storage or Digital Video Content Recorder mass storage may be allocated to one or more Video on Demand Libraries. This mass storage is accessible by Video Content Host Site or Digital Video Content Recorder video on demand transmission and streaming applications, application server computers, application software programs and multi-media communication network infrastructure. This mass storage may be located at the Video Content Host Site head-end, super head-end or multi-media content server facility or within a Digital Video Content Recorder and may be any suitable multi-media file storage media.

A Video on Demand Library may store Subscriber Assets, which are Electronic Content Asset multi-media files owned by subscribers. A Personal Video Archive thus comprises mass storage allocations and Electronic Content Asset multi-media files in one or more Video on Demand Libraries. A Personal Video Archive is called a Video on Demand Library, but this designation is merely shorthand for the underlying Personal Video Archive implementation. A Video on Demand Library may store Operator Assets, which are Electronic Content Asset multi-media files owned by Video Content Host Site operators. Operator Assets may also be stored in a Video on Demand Library residing on a Digital Video Content Recorder that is owned by an operator and located at a subscriber premises. A Video on Demand Library that exclusively stores Subscriber Assets is called a Subscriber Library. A Video on Demand Library that exclusively stores Operator Assets exclusively is called an Operator Library. A Video on Demand Library may contemporaneously store both Subscriber Assets and Operator Assets.

Conceptually, a Video on Demand Library is any data structure, abstract data type or object model comprising an Electronic Content Asset Catalog and an Electronic Content Asset Storage Facility. One or more Video on Demand Library instances may exist contemporaneously on Video Content Host Site mass storage or on Digital Video Content Recorder mass storage. Each Video on Demand Library instance may be accessible by name and may exist, for example, as or within one or more databases, file systems or custom software applications. Each Video on Demand Library Electronic Content Asset multi-media file is accessible, by name or otherwise, to the Video Content Host Site software applications or Digital Video Content Recorder software applications that must process it, such as video on demand transmission or streaming applications.

Electronic Content Asset multi-media files and Electronic Content Asset Metadata multi-media files stored in Video on Demand Libraries are called Distinct Assets. Identical copies of a Distinct Asset may exist contemporaneously within one or more Video on Demand Libraries. The Electronic Content Asset Publication System tracks ownership by a particular subscriber or operator for each Distinct Asset and may support ownership-related queries for Distinct Assets. Electronic Content Assets, Electronic Content Asset Metadata and Distinct Assets are also called Video on Demand Assets. A Video on Demand Library configuration may consist in a single Video on Demand Library instance containing Subscriber Assets and Operator Assets. A Video on Demand Library configuration called a Spanned Library consists in a Subscriber Library for each subscriber and one or more Operator Libraries. Other Video on Demand Library configurations are possible.

The Electronic Content Asset Catalog indexes the Electronic Content Asset multi-media file collection comprising a Video on Demand Library configuration. This multi-media file collection is stored in the Electronic Content Asset Storage Facility of this Video on Demand Library configuration. An Electronic Content Asset Catalog Entry stores a set of attributes for an Electronic Content Asset multi-media file as metadata that may include but is not limited to the Electronic Content Asset name, Electronic Content Asset multi-media file name, Electronic Content Asset type, Electronic Content Asset Identifier, Electronic Content Asset Multiplicity, Electronic Content Asset creation date, Electronic Content Logical Delete Indicator, Electronic Content last reference date, Electronic Content owner, Electronic Content access permissions and the Electronic Content Asset File Location.

The ingest, upload, recording, copy, import, file transfer, archive, backup/restore, purchasing and leasing functions of Network Video Content Recorders, streaming media applications, Digital Content Video Recorders and Video Content Host Site application software programs, any of which may be provided by operators and which may be accessible by subscribers, create, write, update or store Electronic Content Asset multi-media files and Electronic Content Asset Metadata multi-media files in Subscriber Libraries or Operator Libraries. Any function that creates or stores Electronic Content Assets or Electronic Content Asset Metadata may implement an Asset Duplication Strategy. The Asset Duplication Strategy determines the number of identical copies of an Electronic Content Asset to be created or stored. Any function that stores Electronic Content Assets or Electronic Content Asset Metadata may implement an Asset Placement Strategy to select a Video on Demand Library instance for the new Distinct Asset. The Asset Placement Strategy selects a Video on Demand Library instance to store the Electronic Content Asset Catalog Entry and selects a Video on Demand Library instance to store the associated Distinct Asset multi-media file; the Asset Placement Strategy may select the same library in both cases, or it may select two different libraries. Further, for a Spanned Library configuration, the selected library instances may be Subscriber Libraries, Operator Libraries, or one of each depending on requirements. The search/playback and video on demand functions of Network Video Content Recorders, streaming media applications, Digital Content Video Recorders and Video Content Host Site application software programs, which may be accessible by subscribers, read or retrieve Electronic Content Asset multi-media files and Electronic Content Asset Metadata multi-media files stored in Subscriber Libraries or Operator Libraries. Electronic Content Asset Publication System video processing applications may analyze a subscriber's Personal Video Archive content and store the results in the subscriber's Personal Video Archive. Personal Video Archive content is organized or indexed by attributes such as Electronic Content Asset name, creation date and time, source (e.g., Digital Video Content Recorder, Network Video Content Recorder), camera identity, etc., and is indexed for random-access retrieval or video on demand retrieval by these attributes.

For each Electronic Content Asset Publication System subscriber account hosted at a particular Video Content Host Site, the Video Content Host Site operator may store the associated Personal Video Archive entirely at that site. If the Video Content Host Site operator owns or operates multiple Video Content Host Sites, the operator may disperse its Personal Video Archive mass storage over several Video Content Host Sites and store part of a subscriber's Personal Video Archive at one Video Content Host Site and the remainder at one or more other Video Content Host Sites. Similarly, the Electronic Content Asset Publication System subscriber account database mass storage may be centralized or distributed as the Video Content Host Site operator sees fit.

A Video Content Host Site operator may implement mass storage policies, typically including a quota system which indicates the maximum amount of Video Content Host Site Personal Video Archive mass storage a subscriber may allocate. The subscriber's current Personal Video Archive allocation may not exceed the quota. Personal Video Archive storage policies are rules that govern mass storage usage, including but not limited to, the length of time to retain a subscriber's stored Electronic Content Asset multi-media files; what to do when a subscriber's Personal Video Archive storage allocation reaches the quota; and so on. Storage policy examples include, but are not limited to, deleting the oldest stored Electronic Content Asset multi-media files to make room for new Electronic Content Asset multi-media files; automatically procuring additional Personal Video Archive capacity when the quota is reached, thereby dynamically establishing a new quota (“storage on demand”); and so on.

The Video Content Host Site subscriber access is typically web-based or network-based. A Video Content Host Site runs one or more web servers as portals to host subscriber logins and to serve GUI-WEB web pages. Subscribers and software applications may also access Video Content Host Site functions over the network via Electronic Content Asset Publication System GUIs and APIs. Video Content Host Site server computers host subscriber login sessions and Electronic Content Asset Publication System software applications launched by subscribers or operators, including but not limited to, one or more Network Video Content Recorders, streaming media applications, ingest applications, upload services, archive/retrieval operations, video processing applications, and so on. Other Video Content Host Site server software provides support for Electronic Content Asset Publication System GUI and API functions including but not limited to account management, streaming media applications, Electronic Content Asset creation, composition and publication, Electronic Content Asset Gateway, Personal Video Archive management, security policy administration and enforcement, and so on. Subscribers and operators use Network Video Content Recorders and streaming media applications to stream, or to record as subscriber Distinct Assets or operator Distinct Assets, the following content sources: network camera feeds, television programming, Digital Video Content Recorder network streams or any other content sources.

The essence of the Video Content Host Site is a centralized Electronic Content Asset repository; a centralized subscriber web portal; a centralized subscriber database and account administration function; a centralized control point for Electronic Content Asset and Electronic Content Asset Metadata creation, storage, processing and distribution; a platform for Electronic Content Asset Publication System software applications; a central control point for the Publisher/Subscriber Model; an Electronic Content Asset Gateway platform; a central control point for Network Video Content Recorders and streaming media servers and applications; a central control point for recording network camera streams, television programming and other content sources; and other functions explained herein. Further, as an IT datacenter, a Video Content Host Site has myriad physical and logical realizations.

The Electronic Content Asset Publication System uses various techniques at step 307 and elsewhere during operation to classify and index content and to organize Electronic Content Assets for subscriber search operations to supplement the Electronic Content Asset data or metadata provided by the Publisher. Subject classification and indexing is an important value-added service that helps subscribers efficiently and effectively navigate an enormous array of content, by maximizing the likelihood that the search results are compact and contain the desired item(s). Unlike textual content, which is trivially amenable to algorithmic classification methods, video content typically must be interpreted and classified manually or with specialized video analytics applications. The classification process involves reviewing content for various attributes or characteristics of interest, noting those that apply and loading classification databases with the resulting descriptive metadata. Subscribers may browse Electronic Content Asset collections by any of the stock classification categories provided by the Electronic Content Asset Publication System, or they may search the classification databases directly by posing ad hoc queries. Searches may return available titles and Electronic Content Asset Catalog Entry information such as the location of an Electronic Content Asset, which may reside inside (Electronic Content Asset Internal Location) or outside (Electronic Content Asset External Location) of the present Electronic Content Asset Publication System.

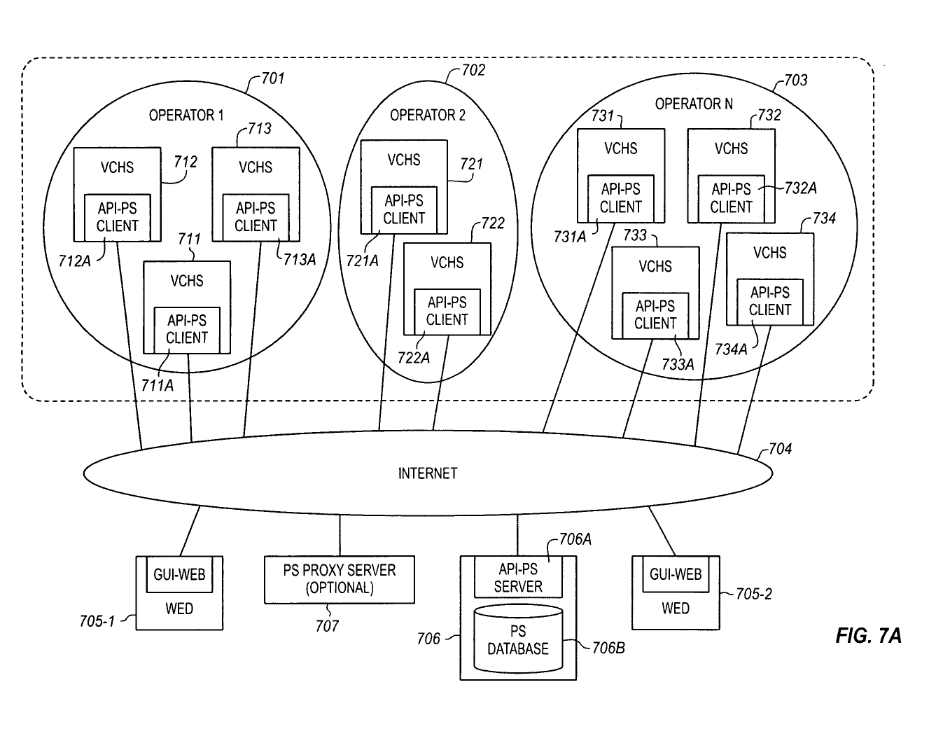

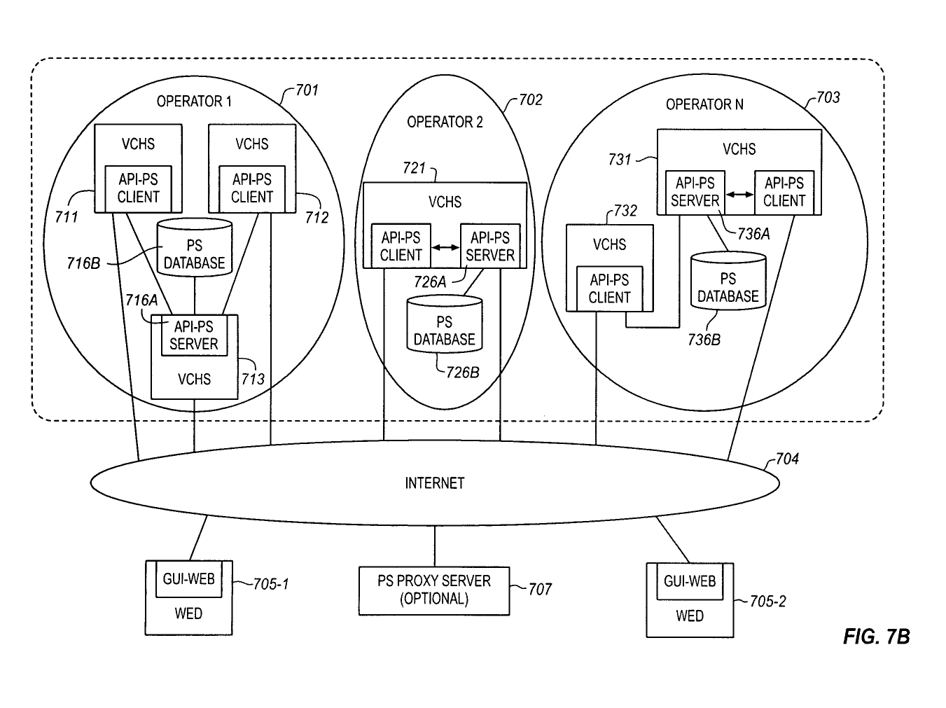

FIG. 7A illustrates, in block diagram form, a centralized Publisher/Subscriber database architecture where the database is shared among multiple operators. This figure illustrates three operators 701-703, each of which includes a plurality of Video Content Host Sites (711-713, 721-722, and 731-734, respectively) for the storage of Electronic Content Assets. FIG. 7B illustrates, in block diagram form, a distributed Publisher/Subscriber database architecture where the Publisher/Subscriber databases 716B, 726B, and 736B are shared via associated API-PS Servers 716A, 726A, and 736A among multiple operators. This figure illustrates three operators 701-703, each of which includes a plurality of Video Content Host Sites (711-713, 721, and 731-732, respectively) for the storage of Electronic Content Assets. A distributed Publisher/Subscriber database consists in the logical union of centralized Publisher/Subscriber databases belonging to all of the affiliated operators. Multiple Publisher/Subscriber databases 716B, 726B, and 736B may be for different purposes, e.g., one database for all subscriber video content and another for a multi-operator aggregate video on-demand library.

### Electronic Content Asset Gateway

The Electronic Content Asset Publication System contemporaneously hosts one or more federations of Video Content Host Site operators comprising the entire Electronic Content Asset Publication System operator membership. Electronic Content Assets published throughout a federation are defined in one or more Publisher/Subscriber databases for that federation. Subscribers or operators belonging to a federation can exchange Electronic Content Assets with one another via an Electronic Content Asset Gateway, which is part of a Video Content Host Site. Each federation within an Electronic Content Asset Publication System may implement its own Electronic Content Asset Gateway system. The Electronic Content Asset Gateway facilitates Content-on-Demand content ubiquity among all subscribers served by an operator federation. The Electronic Content Asset Gateway is content and network agnostic and enables Electronic Content Asset exchange among any multi-media communication networks. The idealized Electronic Content Asset Gateway implementation is a client/server or peer-to-peer multi-media communication network model that places an Electronic Content Asset Gateway API (API-Electronic Content Asset Gateway) server at each Video Content Host Site. The API-Electronic Content Asset Gateway server may logically reside within the Video Content Host Site's Network Access Layer, which is a portal for all Video Content Host Site multi-media communication network access. Each API-Electronic Content Asset Gateway server accepts Electronic Content Asset requests from Video Content Host Sites. An API-Electronic Content Asset Gateway client attempts to retrieve an Electronic Content Asset on behalf of a specified Authorized Subscriber. The API-Electronic Content Asset Gateway server provides the requested Electronic Content Asset to the Authorized Subscriber over one or more network-addressable streams. The API-Electronic Content Asset Gateway idealized client/server protocol is as follows. Typically, the client and the server are hosted by two different Video Content Host Site operators. For Authorized Subscriber Electronic Content Asset access, an Electronic Content Asset Publication System client 1114 requests access via API-Electronic Content Asset Gateway to a specified Electronic Content Asset on behalf of a specified subscriber 1002 and 1003. The client may consult a Publisher/Subscriber database to determine which Video Content Host Site to contact via the Electronic Content Asset Gateway in order to retrieve the requested Electronic Content Asset. The API-Electronic Content Asset Gateway client request may include the requesting subscriber's unambiguous identity credentials. The API-Electronic Content Asset Gateway server 1011 may authenticate the requesting subscriber's unambiguous identity credentials and may consult the appropriate Publisher/Subscriber database to determine if the requesting subscriber is an Authorized Subscriber for the requested Electronic Content Asset. If not, the server fails the request; otherwise, the server launches the requested Electronic Content Asset and returns to the client the multi-media communication network address of each stream comprising the Electronic Content Asset. The API-Electronic Content Asset Gateway client returns these stream addresses to the requesting application, which is then free to access or deliver the Electronic Content Asset via these streams. While this idealized example uses streams to exchange Electronic Content Assets among operators, the Electronic Content Asset Gateway encompasses any software-based means of exchanging content among a group of operators including file transfer protocols, file sharing protocols or any other software-based means of exchanging Electronic Content Assets. Further, different operators might use different implementations of the Electronic Content Asset Gateway, but such operators will provide details for other operators to invoke these implementations. Therefore, the essence of the Electronic Content Asset Gateway, regardless of its implementation, is a multi-media communication network portal system spanning all of the operators in an Electronic Content Asset Publication System federation and providing, most generally, any-to-any multi-media communication network connectivity among these operators for exchanging Electronic Content Assets. The Electronic Content Asset Gateway also enables television operators within the same Electronic Content Asset Publication System federation to pool their Operator Assets for access by each other. Any operator within a federation may register their Operator Assets in a Publisher/Subscriber database and may publish each such Operator Asset to some or all other operators in the same federation as the publisher. Subscribers 1002 and 1003 may browse such an aggregated video on demand Operator Asset collection via a menu that may be based on an API-Publisher/Subscriber application. When a subscriber hosted by a first operator in a federation selects an Operator Asset hosted by a second operator in the same federation, the first operator's video on demand implementation may use the Electronic Content Asset Gateway to access the requested Operator Asset from the second operator on behalf of the subscriber.

In a multi-media communication network, and in particular where communications between subscribers and/or between a subscriber and a content source spans multiple multi-media communication networks, the original Electronic Content Asset may need to be reformatted or translated for compatibility. This is to account for the differences in capabilities of various subscriber devices as well as differences in capabilities of the communication media that are used to serve the subscribers. Therefore, a Translation/Transcoding system can be provided to effect this conversion of program content. The Translation/Transcoding system can be implemented in the Electronic Content Asset Gateway or can be a separate entity available to the multi-media communication network or can be implemented as a part of some other element in the multi-media communication network. For example, an IPTV operator and a QAM-based cable operator who wish to exchange streams must bridge the differences between their respective stream transport methods, perhaps by implementing specialized hardware or software Translation/Transcoding systems to achieve compatibility with Electronic Content Asset Publication System requirements. Further, an operator might wish to impose quality of service (QoS) requirements on streams provided by a different operator. The API-Electronic Content Asset Gateway allows operators to specify file or data formats, Translation/Transcoding specifications, transmission protocols, QoS parameters or any other parameters controlling or affecting Electronic Content Asset exchange via the Electronic Content Asset Gateway. The API-Electronic Content Asset Gateway implementation may incorporate various security mechanisms to verify that an Electronic Content Asset Publication System client is authorized for access, or that an Electronic Content Asset Publication System operator is authorized for access.

### Video On-Demand

Well known in the art, Video On-Demand television service requires a digital set top box or an equivalent television receiver and allows the viewer to choose video content from an inventory of available on-demand video content. This inventory typically numbers in the hundreds of titles and is usually organized by genre. Content is traditionally determined by the cable companies and the networks, studios and broadcasters with whom they conduct business. Most titles are replaced with fresh content every few weeks. A Video On-Demand asset is therefore typically a digital video file stored on mass storage accessible to the Video On-Demand operator, for on-demand transmission to Video On-Demand subscribers. This mass storage system may be located at an operator's head-end, super head-end or content server facility and may be any suitable digital storage media. Once an asset is selected for viewing, playback starts immediately from the beginning, just as if the viewer were watching a DVD. The set top box and its remote control provide DVR-like controls over playback, e.g., play, pause, rewind and fast-forward. The viewer may interrupt playback at any time, e.g., to return to live television, and may resume playback at the point of interruption at a later time. All major cable operators provide Video On-Demand services, and satellite operators require a return path from the set top box to provide true Video On-Demand services. Most Video On-Demand content comprises movies, although certain television shows or episodes may be available. On-Demand content from premium networks is typically available only to premium subscribers. Fees may apply to some On-Demand titles; a purchased title is usually available for unlimited viewing during a prescribed “rental” period, usually up to 24 hours after the purchase. Many cable companies offer set top boxes with built-in DVRs to record programs as they are broadcast. Enormously popular and convenient, these devices serve mainly to mitigate linear channel schedule constraints, and DVR playback is not generally regarded as a form of Video On-Demand.

Also well-known in the art, Near Video On-Demand television systems repeatedly broadcast the same content over a small number of linear channels, with start times staggered across these channels that are usually separated by 30 minutes or less. Near Video On-Demand does not give the viewer control over the playback start time or the playback process, hence it is merely a strategy to mitigate linear channel schedule constraints. Cable and satellite operators may provide Near Video On-Demand channels.

### Content On-Demand

Content On-Demand is a new multi-media content access paradigm defined by the present Electronic Content Asset Publication System that allows subscribers to dynamically and selectively publish and distribute live and recorded Electronic Content Assets ubiquitously to subscribers of Web-Enabled Devices WEDs), and also to the subscribers of cable, satellite and IPTV television operators. Today's television operators typically own or license all of the content they distribute, and determine what content is broadcast to subscribers, and when that content is available (excluding traditional Video On-Demand content). The Content On-Demand functionality of the Electronic Content Asset Publication System changes today's cable, satellite and IPTV “closed network” video on demand paradigm because the method specifies a wholly dynamic, real-time, interactive model that gives subscribers complete control over Electronic Content Asset acquisition, storage, publication, distribution, viewing and processing. Content On-Demand gives subscribers complete control over who can watch their personal multi-media content, when that content will be available, and on what multi-media network devices that content can be viewed. Further, just as the public Internet gives its subscribers direct access to a global open communication network infrastructure, Content On-Demand gives subscribers direct access to cable, satellite and IPTV broadcast, on-demand and multi-media communication network infrastructures in a new way that not even the commercial production studios enjoy. Even further, Content On-Demand technology enables television subscribers to access the Video On-Demand libraries of multiple affiliated television operators.

### Subscriber Graphical Interfaces

A subscriber may use any of several different subscriber-programmable graphical interfaces (GUIs) to access the present Electronic Content Asset Publication System. These subscriber graphical interfaces are interactive menu systems enumerating any or all Electronic Content Asset Publication System functions available to subscribers and providing the means for subscribers to execute those functions. The GUI-WED interface is any native GUI providing Digital Video Content Recorder access or Video Content Host Site access from a native window system running on any subscriber WED device. The GUI-WEB interface is any web-based GUI providing Digital Video Content Recorder access or Video Content Host Site access from a web browser running on any subscriber WED device. The GUI-IPG interface is any interactive program guide GUI providing Digital Video Content Recorder access or Video Content Host Site access from any subscriber cable, satellite or IPTV set top box or equivalent television receiver device. The GUI-DVCR interface is any web-based GUI providing Digital Video Content Recorder access or Video Content Host Site access from any subscriber WED device.

Any hardware or software platform that hosts GUI-WED, GUI-WEB, GUI-IPG or GUI-DVCR must execute the hosted subscriber graphical interface and must launch any Video Content Host Site or Digital Video Content Recorder software functions, applications or APIs that a subscriber may invoke from a subscriber graphical interface. These hardware and software platforms include but are not limited to subscriber WED devices and platforms; subscriber web browsers; Video Content Host Site web servers, application servers or API servers; Digital Video Content Recorders; cable, satellite or IPTV set top boxes or equivalent television receiver devices; and software application frameworks. These hardware and software platforms must accept an Electronic Content Asset delivery comprising one or multiple simultaneous streams and must provide the ability to audibly and visually render an Electronic Content Asset in the format and layout specified by the Publisher, which is called the default rendition. These hardware and software platforms must provide two-way interactive network communication with a Video Content Host Site, a Digital Video Content Recorder or GUI-WED, GUI-WEB, GUI-IPG or GUI-DVCR and must be able to receive or process synchronous or asynchronous events, notifications, alerts, messages, commands, etc. from any Electronic Content Asset Publication System sources. These hardware and software platforms must be able to execute Video Content Host Site APIs, Digital Video Content Recorder APIs and any other Electronic Content Asset Publication System APIs.

A subscriber may use GUI-WED, GUI-WEB, GUI-IPG or GUI-DVCR to sign-on to the Electronic Content Asset Publication System. The sign-on process may require the subscriber to enter a login name and password and may interact with Video Content Host Site software or Digital Video Content Recorder software to authenticate the subscriber and establish a subscriber login session. Once signed on, a subscriber may access software functions or applications provided by the subscriber graphical interface or by Video Content Host Site software systems or APIs or by Digital Video Content Recorder software systems or APIs. These software functions and applications include the capability to instantiate subscriber-programmable graphical interface design elements including fonts, wallpapers, window borders, decorations, color schemes, natural language selection, icons, etc.; Electronic Content Asset acquisition, creation, recording, composition, layout, publication and processing functions and applications; Authorized Subscriber Electronic Content Asset access, streaming, playback and rendering functions and applications; Authorized Subscriber unambiguous identity credential specification including Electronic Content Asset Publication System sign-on and sign-off functions; subscriber Personal Video Archive storage allocation, storage policy specification and storage administration; Digital Video Content Recorder control and administration functions; personal electronic video retail purchasing or leasing functions; subscriber account administration functions; and any other subscriber capabilities provided by the Electronic Content Asset Publication System.

An Authorized Subscriber may use GUI-WED, GUI-WEB, GUI-IPG or GUI-DVCR to alter an Electronic Content Asset default rendition by programming personalized overrides to the Electronic Content Asset layout canvas. For example, an Authorized Subscriber may alter the layout canvas by rearranging the location of individual windows comprising an Electronic Content Asset, or by specifing personalized window borders, or by deleting windows. Such personalized programmed alterations affect Electronic Content Asset rendition privately upon delivery to the requesting Authorized Subscriber and do not affect the Electronic Content Asset composition specified by the Publisher, stored in the Publisher/Subscriber database or delivered to other subscribers.

Subscriber graphical interfaces may implement content controls such as passwords, parental locks and subscriber-defined on-screen viewing formats, e.g., tiled camera views or rotating views with an adjustable dwell period, and may provide the capability to combine multiple camera feeds as single feeds. Subscriber graphical interface menus or screens may contain fixed content and/or variable content. To serve a variable content menu, Video Content Host Site software or Digital Video Content Recorder software must determine the required content and must use that content to compose the actual menu or screen to be presented to the subscriber. Variable content examples include, but are not limited to, subscriber-specific system configuration data, the list of Electronic Content Assets published to an Authorized Subscriber, and so on.

### Digital Video Content Recorder GUI (GUI-DVCR)

A subscriber may access GUI-DVCR over any Digital Video Content Recorder broadband or IP network interface from a web browser on any suitable Web-Enabled Device WED). The GUI-DVCR implementation resides in Digital Video Content Recorder persistent storage where it is accessible to the Digital Video Content Recorder embedded web server.

GUI-DVCR exposes and invokes all available Digital Video Content Recorder core functions and application services including subscriber, system and network configuration; login authentication; video processing applications including a means to combine multiple cameras feeds as single feeds; Electronic Content Asset creation, publication, playback and streaming; recording schedule creation; “phone-home” support; remote software upgrades including GUI-DVCR updates; remote management services such as SNMP or CIM; etc.

### Subscriber Interactive Program Guide GUI (GUI-IPG)

The GUI-IPG implementation may reside on Video Content Host Site mass storage where it is accessible to the cable, satellite or IPTV distribution system for transmission to subscriber set top boxes or equivalent subscriber television receiver devices. GUI-IPG may be a subordinate menu system to an interactive program guide that is provided by a cable, satellite or IPTV operator and which may provide a navigation link to access GUI-IPG; selecting this link causes the GUI-IPG main menu to be displayed to the subscriber. The subscriber uses the GUI-IPG main menu and its subordinate menus to access Digital Video Content Recorders, Network Video Content Recorders, Video Content Host Site functions and applications, and Electronic Content Assets. GUI-IPG may be functionally equivalent to GUI-WEB and may exhibit identical form.

The two-way, interactive nature of Content On-Demand access requires an active return path from the subscriber's set top box or equivalent subscriber television receiver device to a Video Content Host Site. When an Authorized Subscriber uses GUI-IPG to select an Electronic Content Asset for viewing, the set top box or equivalent transmits the request to the cable, satellite, IPTV or Video Content Host Site operator along the return path. The operator then delivers the requested Electronic Content Asset to the subscriber's set top box or equivalent as a single stream or as multiple simultaneous streams. GUI-IPG displays this content on the subscriber television set in the subscriber-programmed on-screen viewing format, which may be the default rendition specified by the Publisher.

GUI-IPG may obtain from a Video Content Host Site or from some other source a list of Digital Video Content Recorders or Network Video Content Recorders available for subscriber selection. The subscriber selects a device from this list to display the top-level device control menu. The subscriber uses this top-level device control menu and its subordinate menus to access Digital Video Content Recorder or Network Video Content Recorder functions. The GUI-IPG Digital Video Content Recorder menu system may be functionally equivalent to GUI-DVCR and may exhibit identical form. The GUI-IPG Network Video Content Recorder menu system may be functionally equivalent to GUI-WED Network Video Content Recorder controls or GUI-WEB Network Video Content Recorder controls and may exhibit identical form. GUI-IPG may directly control the selected device from the set top box or equivalent. The direct control mode involves GUI-IPG issuing API-Digital Video Content Recorder calls or API-Video Content Host Site calls in a logical point-to-point fashion. In the case of a satellite set top box, GUI-IPG may indirectly control the selected device via a proxy running on a Video Content Host Site. The indirect control mode involves GUI-IPG issuing tagged API-Video Content Host Site calls to the Video Content Host Site proxy application, which forwards those requests to the device indicated by the tag, and which also forwards the results to GUI-IPG.

### Subscriber WED GUI (GUI-WED)

GUI-WED is a software application including a subscriber graphical interface that is ported to one or more target computer platforms. The subscriber graphical interface is a native window system application for the target platform. GUI-WED may also launch a web browser if required for certain functions. GUI-WED is a simple and intuitive tool for viewing Electronic Content Assets from Digital Video Content Recorders or Video Content Host Sites. GUI-WED may also provide access to Digital Video Content Recorders and Network Video Content Recorders similarly to GUI-IPG. GUI-WED is intended as a desktop subscriber graphical interface, although it may also be adapted to other suitable WED platforms. The subscriber downloads the GUI-WED installation kit from a Video Content Host Site and executes the GUI-WED installer.

The GUI-WED installer launches a configuration process that may prompt for subscriber credentials. The installer may contact the Video Content Host Site to authenticate the subscriber and obtain subscriber configuration data from the Video Content Host Site subscriber account database, and may configure GUI-WED to launch as part of the desktop creation process. The GUI-WED application is typically launched as a background process. GUI-WED may create a desktop icon during initialization that may remain visible until GUI-WED terminates. GUI-WED establishes network communication with a Video Content Host Site and with any designated Digital Video Content Recorders or Network Video Content Recorders, and may register to receive alerts and notifications from those entities. At any time, the subscriber may open the GUI-WED subscriber graphical interface in a desktop window by opening the GUI-WED icon with the desktop pointing device or equivalent.

GUI-WED attempts to attract the subscriber's attention by signaling audible or visual cues when it receives an alert or a notification. For example, it may sound a tone or conspicuously pulse its desktop icon. An interested subscriber will open the application to view the alert.

### Subscriber WEB GUI (GUI-WED)

The GUI-WEB implementation may reside on Video Content Host Site mass storage where it is accessible to Video Content Host Site web servers. GUI-WEB may be functionally equivalent to GUI-IPG and may exhibit identical form. A Video Host Content Site hosts a subscriber GUI-WEB sign-on session.

### All Video On-Demand Networks

An All Video On-Demand Network (All-VoD Network) is an interactive television service of the Electronic Content Asset Publication System that provides access to Video On-Demand content, Content On-Demand content and advanced personal services such as electronic video retail sales and leasing. An All-VoD Network may operate as one or more Video Content Host Sites that delivers content to cable, satellite and IPTV operators on a single assigned television channel number. Internet-based subscribers may access All-VoD Network content over Web-Enabled Devices WEDs), typically via a web browser or a desktop GUI application. GUI-WEB or GUI-WED may provide All-VoD Network access. An All-VoD Network implementation may use any of the features, methods, elements, processes or technologies that are part of the present Electronic Content Asset Publication System. Whenever a cable, satellite or IPTV subscriber is tuned to an All-VoD channel, the cable, satellite or IPTV company uses interactive television technology to pass the subscriber's remote-control signals to the All-VoD Network, so the subscriber can navigate on-screen guides, make selections, perform functions and provide information. These signals travel via the subscriber's digital set-top box or equivalent device and are received, interpreted and processed by interactive television technology and specialized application software at the All-VoD Network. All signal processing is performed in a context sensitive fashion, i.e., each signal is interpreted relative to the context or mode in which it originated, e.g., within the context of a particular interactive guide for a particular personal television service. This technique enables an All-VoD Network to tailor the function of each remote-control signal for each subscriber application. An All-VoD Network is not a broadcast network since all content is streamed on demand. All-VoD Network content distribution techniques may include IP multicasting, though most on-demand streams are delivered as IP unicast streams.

A television subscriber who is tuned to an All-VoD Network channel selects from a menu of available content and services including Video On-Demand, Content On-Demand or Personal Services. The All-VoD Network menu system is an interactive program guide which may be a GUI-IPG interface. All-VoD Network Video On-Demand content is a collection of Local Assets and/or External Assets acquired by the All-VoD Network operator from any sources, for on-demand transmission to subscribers. All-VoD Network Content On-Demand content is a collection of Subscriber Assets created or acquired by subscribers in accordance with the Electronic Content Asset Publication System and held in Subscriber Libraries, Video On-Demand Libraries or Personal Video Archives, for on-demand transmission to subscribers in accordance with the Electronic Content Asset Publication System Publisher/Subscriber access control model or equivalent. All-VoD Network Personal Services includes electronic video retail sales or leasing services and any other personalized services provided by an All-VoD Network. A collection of All-VoD Network Video On-Demand content and/or All-VoD Network Content On-Demand content is called an All-VoD Network Library. Any logical index system for an All-VoD Network Library is called an All-VoD Network Library Catalog. For example, any collection of Electronic Content Asset Catalogs spanning one or more All-VoD Network Video On-Demand Libraries logically comprises an All-VoD Network Library Catalog. An All-VoD Network may implement multiple All-VoD Network Libraries or multiple All-VoD Network Library Catalogs contemporaneously.

A Local Asset is any Distinct Asset, i.e., any Subscriber Asset or any Operator Asset, that is stored by an All-VoD Network operator in a Video on Demand Library for on-demand transmission to subscribers or other operators. An All-VoD Network acquires or ingests Local Assets via any suitable means including Internet file transfer, satellite downlink, Electronic Content Asset Publication System methods or any other method. An Electronic Content Asset that is stored by a Relay source or a Broker source as defined herein is called an External Asset. An External Asset is not ingested or stored by an All-VoD Network but is cataloged in an All-VoD Network Library Catalog. The All-VoD Network Library Catalog entry for an External Asset contains the multi-media communication network address of an application server that accepts commands from an All-VoD Network to stream or transmit the External Asset in accordance with the Relay or Broker models. This multi-media communication network address may consist of the server hostname or IP address and the application server port number.

An All-VoD Network may title, classify or index Local Assets and External Assets for on-demand access via an All-VoD Network Library Catalog. Titling, classification and indexing operations produce Electronic Content Asset Metadata that is placed in mass storage where it is accessible to All-VoD Network search engines or applications that may process it, e.g., interactive program guide applications that generate and format lists of titles, display search results, etc. An All-VoD Network may store other forms of Electronic Content Asset Metadata including soundtrack dialogue, song lyrics and subtitles, which are logically expressed as searchable text. An All-VoD Network may acquire this metadata from a supplier such as the content owner or a translation service provider, or an All-VoD Network may generate this metadata using its own translation processes, wherein this metadata may comprise valuable intellectual property owned by the All-VoD Network operator.

Electronic Content Asset Metadata stored on All-VoD Network mass storage is called Local Metadata, which may reside in an All-VoD Network Library or apart from an All-VoD Network Library, and in either case an associated All-VoD Network Library Catalog may store the actual location(s) where the Local Metadata for an Electronic Content Asset is stored. An All-VoD Network may temporarily acquire a copy of an External Asset, e.g., via an Internet file transfer operation, to prepare Local Metadata for that External Asset. The Electronic Content Asset Metadata for an External Asset may be stored by the All-VoD Network as Local Metadata or may be stored external to the All-VoD Network as External Metadata, or it may be stored as a combination of Local Metadata and External Metadata. An All-VoD Network Library Catalog may store the actual location(s) where the External Metadata for an Electronic Content Asset is stored.

An All-VoD Network may employ any of the following three on-demand Electronic Content Asset distribution models in whole or in part, or in various combinations. Distribution of a single-stream Electronic Content Asset is described for clarity. This description readily generalizes to include an Electronic Content Asset comprising multiple streams:
Central Server Model: A subscriber selects a Local Asset for playback. The playback process may invoke All-VoD Network identity management software to determine which subscriber issued this playback request, and it may also invoke asset utilization software to record the fact that this particular Local Asset was selected for playback, including the playback date and time. The playback process may utilize the Electronic Content Asset Publication System Publisher/Subscriber access control model or any other access control model to validate the playback request and grant access for playback. The playback process then locates the Local Asset media via the Local Asset's All-VoD Network Library Catalog entry and readies the Local Asset media for playback, which may include staging the Local Asset on storage media accessible to a streaming server. The playback process then activates a streaming server to launch a stream containing the selected Local Asset to the cable company, which forwards this stream to the subscriber's set top box or equivalent, which in turn transmits the video content to the subscriber's television set. This playback model requires content and technology compatibility between the All-VoD Network and the cable company. Such compatibilities may be achieved by the Electronic Content Asset Gateway.
Relay Model: A subscriber selects an External Asset for playback. The playback process may perform identity management, asset utilization or access control functions as with Central Server Local Asset playback. The playback process inspects the All-VoD Network Library Catalog entry for the External Asset to obtain the network address of a Relay source that can stream the selected External Asset. The playback process may use the Electronic Content Asset Gateway to obtain the requested External Asset on a stream launched by this Relay source. The playback process then launches a stream to the cable company (it may use the Electronic Content Asset Gateway to do so) and forwards the Relay source stream to the cable company stream by logically coupling these two streams compatibly. The cable company forwards this stream to the subscriber's set top box or equivalent, which renders the video content on the subscriber's television set. This playback model requires content and technology mutual compatibility between the All-VoD Network, the Relay source and the cable company. Such mutual compatibilities may be achieved via the Electronic Content Asset Gateway.
Broker Model: A subscriber selects an External Asset for playback. The playback process may perform identity management, asset utilization or access control functions as with Central Server Local Asset playback. The playback process inspects the All-VoD Network Library Catalog entry for the External Asset to obtain the network address of a Broker source that can stream the External Asset to the cable company. There are several variations on the remainder of the playback process depending on requirements. In the first variant, the playback process forwards the Broker source address to the cable company, possibly via the Electronic Content Asset Gateway, which contacts the Broker source directly on behalf of the subscriber (“pull” model), again possibly via the Electronic Content Asset Gateway; the Broker source launches a stream to the cable company for delivery to the subscriber's television. In the second variant, the playback process forwards information about the cable company and the requesting subscriber to the Broker source, which contacts the cable company on behalf of the subscriber (“push” model); the Broker source launches a stream to the cable company, which delivers it to the subscriber. In the third variant, the playback process requests the Broker source create a playback stream and return the stream address; the playback process forwards the stream or the stream address to the cable company, which accesses the stream at the indicated address and forwards it to the subscriber's set top box or equivalent; communication between all parties might occur via the Electronic Content Asset Gateway. The Broker model requires content and technology mutual compatibility between the All-VoD Network, the Broker source and the cable company. Such mutual compatibilities may be achieved via the Electronic Content Asset Gateway.

The Central Server model assigns Electronic Content Asset storage and distribution responsibilities to the All-VoD Network. The Relay model shifts the storage responsibility to a separate party. The Broker model shifts storage and distribution responsibilities to separate parties. The Relay and Broker models may utilize custom, network-centric application programming interfaces (Relay/Broker APIs) to request, launch or broker streams between parties. An All-VoD Network may implement multiplicities of these three models simultaneously, e.g., multiple Central Server and Relay sites combined with multiple Broker relationships. In all cases, the parties must implement mutually compatible video on demand technologies. Electronic Content Assets must be compatible with all distribution systems through which they must pass. Incompatible Electronic Content Assets must be amenable to translation for end-to-end compatibility. Such translations may occur before or during streaming, perhaps by using real-time data format or transmission protocol conversion techniques. These three Electronic Content Asset distribution models define a key difference between the All-VoD Network and Internet video sites such as YouTube. In addition to the ability to stream Electronic Content Assets to Internet subscribers on demand, an All-VoD Network functions logically as a cable television quasi head-end or quasi super head-end system that may be linked to multiple cable operators or multiple cable distribution systems, and an All-VoD Network may also function as a broker between compatible asset producers and consumers. But without its own cable distribution facilities, an All-VoD Network does not function as a true cable head-end or super head-end system because it cannot reach subscriber set top boxes directly, hence the terms quasi head-end and quasi super head-end system. The All-VoD Network cable access protocols are separate from the basic cable access protocol described below, and all of these protocols may operate contemporaneously within the present Electronic Content Asset Publication System. An All-VoD Network operator may combine multiple simultaneous streams comprising an Electronic Content Asset to reduce the number of streams that are delivered concurrently to the subscriber. When delivering an Electronic Content Asset that has been combined in such a fashion, the All-VoD Network operator will notify the subscriber's All-VoD Network interactive program guide accordingly, whereupon the interactive program guide will adapt to process fewer streams for this Electronic Content Asset than the Publisher specified. An All-VoD Network may also replicate Central Server Model, Relay Model or Broker Model implementations for fault tolerance and performance.

All-VoD Network applications, e.g., search engines, may use Relay/Broker API extensions to access External Metadata. An All-VoD Network may employ data replication technologies to distribute multiple copies of its Distinct Assets in a controlled fashion, e.g., to strategically disperse Local Assets or Local Metadata across a wide geographic area to improve fault tolerance or network load balancing, or to reduce subscriber access times. An All-VoD Network may employ hierarchical storage management to improve mass storage cost-effectiveness, e.g., a Local Asset may migrate from primary disk to secondary disk to magnetic tape to optical storage and then back again depending on its access profile over time. An All-VoD Network may employ computer network security and data protection schemes such as encrypted streaming, encrypted file transmission and encrypted data storage; client/server digital certificates; public key infrastructure (PKI); secure web access; etc.

An All-VoD Network relies on identity management technology to bill its subscribers, transact video retail operations, compile and analyze subscriber demographics, implement personal Content On-Demand content ubiquity services including personal Electronic Content Asset publishing and sharing, etc. All-VoD Network identity management broadly consists in uniquely establishing or authenticating trustworthy subscriber credentials for individual transactions or requests, e.g., name, address, phone number, account number, login name, login password, etc. All-VoD Network partners, e.g., cable companies, may provide subscriber credentials with each interactive subscriber request forwarded by the cable company to the All-VoD Network; in this case, the cable company uses its own methods to determine subscriber identify, e.g., by mapping unique information provided by a digital set top box to a subscriber account. An All-VoD Network may maintain its own subscriber database, e.g., to store subscriber records for billable services such as personal Electronic Content Asset storage, or to establish a login service for universal access from any suitable device. An All-VoD Network may also query its own subscriber database using subscriber credentials provided by a cable company, to determine if the cable subscriber holds access entitlement for the requested All-VoD Network service or function.

An All-VoD Network may develop its own interactive personal television menus based on its own human-computer interaction (HCI) research. These menu systems may be GUI-WEB, GUI-WED, or GUI-IPG menu systems. Logical, intuitive and powerful, these simple-to-navigate and easy-to-use menus and guides are access portals for all All-VoD Network Library content and personal services. All-VoD Network guides and menus are designed for compatibility with existing interactive television technology employed by partner cable companies. In addition to its original technology, an All-VoD Network menu system may incorporate best practices from web interface design and personal computing such as drop-down lists, check-boxes, radio buttons, scrolling, inset picture(s), picture-in-picture, reserved areas for ad space, tiled layouts or views, etc. Menus allow easy data entry methods to compose queries, enter personal preferences, etc. Subscribers may personalize the menu system to further enhance the personal television experience. An All-VoD Network may store a subscriber menu preference in a database, and All-VoD Network software may apply these preferences to compose personalized screens in real time. Allowable customizations may include but are not limited to locale (e.g., English, Spanish, and Dutch), borders, backgrounds, screen-savers, layout, colors, font size/type, icons, etc.

An All-VoD Network may conduct demographics research based on subscriber data and subscriber metadata. An All-VoD Network may use demographics research to identify individual subscribers or subscriber groups for targeted advertising, or to identify new markets or opportunities for new goods or services. Subscriber data includes subscriber account information and any personal information the subscriber provides voluntarily, e.g., interests, hobbies, languages spoken, age, gender, ethnicity, etc. Subscriber metadata includes data about subscriber activity: what shows the subscriber watched, and when; what searches the subscriber conducted; which personal services the subscriber used; how the subscriber personalized their interactive menus; and any other subscriber metadata. Subscriber metadata may also include information obtained from an All-VoD Network's identity management services or data obtained from subscriber surveys or polls. An All-VoD Network may store subscriber data and subscriber metadata in a database. An All-VoD Network may analyze this database to correlate, infer or discern subscriber behavior, trends, needs, or other aspects of its subscribers. Analyses may focus on individuals or groups of subscribers related by common interests, preferences or viewing activities. An All-VoD Network may analyze individual subscriber demographics in real time and use the results to immediately deliver targeted advertising to that subscriber. An All-VoD Network may occasionally compile and post such personalized recommendations to subscriber electronic mailboxes provided by the All-VoD Network and accessible from the interactive program guide, and a subscriber may browse his or her electronic mailbox at any time to read these suggestions. An All-VoD Network may also scroll personalized recommendations in tickers or other reserved areas on the screen. Sophisticated subscriber demographics analyses, like sophisticated content classification schemes, are a significant value-add service. An All-VoD Network may invest heavily in demographics research to hone its competitive edge and enhance subscriber satisfaction. An All-VoD Network may enforce a strict privacy policy that limits the use of all subscriber information processed by, and produced from, its demographics analyses.

An All-VoD Network may bill its subscribers for certain personal services or transactions, e.g., Personal Video Archive storage allocation or video retail transactions. Transaction processing applications will collect or generate information about subscriber transactions including, where applicable, service or transaction date and time; subscriber identity, service or transaction code; service or transaction units acquired or used; etc. These applications may use All-VoD Network identity management services to determine which subscriber performed each transaction. An All-VoD Network may store subscriber transaction information in a database and may create transaction audit files or log files. All-VoD Network billing applications use subscriber transaction data to generate or post subscriber statements or invoices. An All-VoD Network may also track Network Library asset utilization including how many times a title is streamed during a given period of interest. An All-VoD Network may store this asset utilization information in a database. All-VoD Network royalty accounting systems may use this asset utilization data to generate royalty statements for content owners or distributors.

An All-VoD Network operates a web site for access from subscriber WED devices that offers equivalent functionality to its interactive cable television menus. The web site implementation may be a GUI-WEB implementation. An All-VoD Network may store subscriber login credentials, e.g., login name and password, in a database. The web login process may read this database or invoke network identity management services to perform subscriber authentication. Once logged in, a subscriber may access any All-VoD Network subscriber service or function. An All-VoD Network's personal video services may utilize or adapt the Electronic Content Asset Publication System content ubiquity models for sharing live and recorded video, home/business monitoring, social networking, community television, videoconferencing, etc. These content ubiquity models allow personal Electronic Content Assets to traverse multiple, autonomous, potentially dissimilar multi-media networks and network operators, e.g., cable, satellite, IPTV and the Internet, just as long-distance telecommunications services span multiple autonomous telecommunications networks to connect callers.

### Electronic Content Asset Access

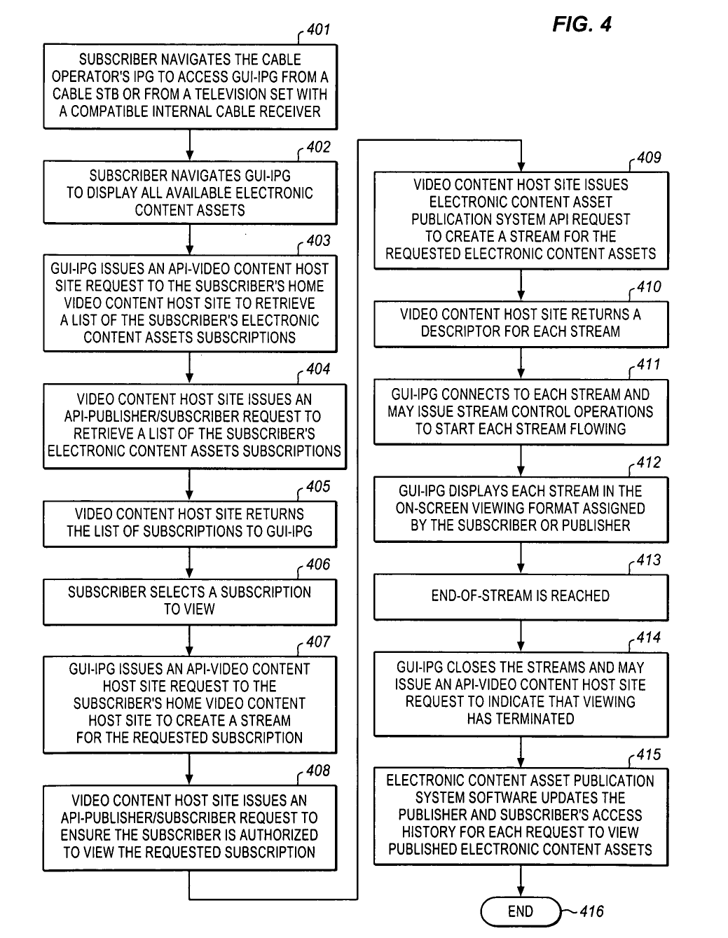

The Publisher/Subscriber access control model validates each access request for a specified Electronic Content Asset as illustrated in flow diagram form in FIG. 4. First, the Publisher/Subscriber access control system uses any suitable method to authenticate the requesting subscriber's unambiguous identity credentials. Next, the Publisher/Subscriber access control system searches for the requesting subscriber's unambiguous identity in the Authorized Subscriber List associated with the requested Electronic Content Asset. The Publisher/Subscriber access control system rejects the access request if the requesting subscriber is not an Authorized Subscriber. Finally, the Publisher/Subscriber access control system grants the access request only if it satisfies all applicable terms-of-use for the requested Electronic Content Asset. Electronic Content Asset definitions, publication relations, Authorized Subscriber Lists and terms-of-use are examples of Publisher/Subscriber data elements. All Publisher/Subscriber data elements are stored on mass storage in a Publisher/Subscriber database. The Publisher/Subscriber database access method is termed the Publisher/Subscriber API herein.

A Publisher/Subscriber database spans an entire Electronic Content Asset Publication System operator federation but may exclude any or all All-VoD Networks, which may implement separate Publisher/Subscriber database systems. All operators in a federation agree to share with the entire federation their Publisher/Subscriber databases that are defined for that federation. Further, multiple federations might coexist as or within separate instances of the Electronic Content Asset Publication System, but the Publisher/Subscriber database content of each federation is private to that federation. The Publisher/Subscriber database model may be centralized or distributed. A centralized Publisher/Subscriber database is stored in its entirety at a single site, which may be a Video Content Host Site. A distributed Publisher/Subscriber database consists in the logical union of Publisher/Subscriber databases belonging to all of the operators comprising an Electronic Content Asset Publication System federation. While an idealized Publisher/Subscriber database model might be either centralized or distributed, other database models or database access methods are possible, and different operators within the same federation might use different implementations, but the essence of the Publisher/Subscriber model, regardless of implementation, is a database and a database access method that spans a federation, and which enables any Publisher/Subscriber database client application in the federation to access the Publisher/Subscriber database in its entirety across all such database instances spanning the entire federation. An Electronic Content Asset Publication System federation may implement multiple Publisher/Subscriber databases for different purposes, e.g., one database for all subscriber Electronic Content Assets and another one for a multi-operator aggregate Video On-Demand library. Any operator or a federation of operators may replicate a Publisher/Subscriber database for fault tolerance or performance.

### Cable TV Access

A Digital Video Content Recorder CATV output connector may be wired directly to a cable-ready television set or combined with a cable TV feed and distributed to one or more cable-ready television sets over a local cable distribution network, such as a residential home-run wiring system. Digital Video Content Recorder output is available on the cable channel number assigned by the Digital Video Content Recorder subscriber. This channel number is chosen so as not to interfere with a combined cable feed. Electronic Content Assets may also be distributed on demand by a cable operator. The present Electronic Content Asset Publication System cable network connectivity model assumes any two Electronic Content Asset Publication System elements within a single cable operator's Electronic Content Asset Publication System may communicate with each other via Electronic Content Asset Publication System APIs in a logical point-to-point fashion. How the cable operator implements this logical connectivity requirement is unimportant. The present Electronic Content Asset Publication System network connectivity model also assumes GUI-IPG can access an Electronic Content Asset from another Video Content Host Site operator in the same Electronic Content Asset Publication System federation as the GUI-IPG cable operator, in a logical point-to-point fashion. GUI-IPG multi-media communication network traffic might pass through one or more cable plant head-end systems before reaching its destination. Further, the cable operator may choose to deliver a stream by multicasting at the head-end system for efficiency.

The present Electronic Content Asset Publication System basic cable access protocol for Electronic Content Assets is illustrated in flow diagram form in FIG. 4. The cable subscriber navigates at step 401 the cable operator's interactive program guide (IPG) to access GUI-IPG from a cable set top box (STB) or from a television set equipped with a compatible cable receiver. The subscriber may then use GUI-IPG to sign on to the Electronic Content Asset Publication System and enter his or her subscriber unambiguous identity credentials. From there:
1. The Subscriber navigates GUI-IPG to display all Electronic Content Assets that have been published to the Subscriber at step 402.
2. GUI-IPG issues an API-Video Content Host Site request to the Subscriber's Home Video Content Host Site at step 403 to retrieve a list of the Subscriber's Electronic Content Asset subscriptions. A cable Subscriber's Home Video Content Host Site is assigned by the cable operator.
3. Video Content Host Site at step 404 issues an API-Publisher/Subscriber request to retrieve a list of the Subscriber's Electronic Content Asset subscriptions.
4. Video Content Host Site at step 405 returns the list of subscriptions to GUI-IPG, which displays them for the Subscriber. Each list entry details the subscription source and may include but is not limited to the Publisher's Home Video Content Host Site operator identity, the Publisher's Home Video Content Host Site identity or network address, the Publisher's unambiguous identity and the identity of the published Electronic Content Asset. A Publisher's Home Video Content Host Site is assigned by a Video Content Host Site operator.
5. The Subscriber selects a subscription to view at step 406.
6. GUI-IPG issues an API-Video Content Host Site request at step 407 to the Subscriber's Home Video Content Host Site to create a stream for the requested subscription. The request includes the subscription source information from step 405.
7. Video Content Host Site may issue an API-Publisher/Subscriber request at step 408 to ensure the Subscriber is authorized to view the requested Electronic Content Asset. If the Subscriber is not authorized, Video Content Host Site fails the request and processing exits at step 416.
8. Video Content Host Site issues an Electronic Content Asset Publication System API request at step 409 to create a stream for the requested subscription including the preferred streaming protocol (see below). A separate stream may be created for each Electronic Content Asset comprising the published Electronic Content Asset. The streaming protocol may provide content delivery controls, e.g., STOP, PAUSE, PLAY, REWIND, etc.
9. Video Content Host Site at step 410 returns a descriptor for each stream comprising the subscription to GUI-IPG. A stream descriptor may include, but is not limited to, an IP address, a port number and the streaming protocol in use.
10. GUI-IPG connects to each stream at step 411 and may issue stream control operations to start each stream flowing (if necessary).
11. GUI-IPG displays each stream at step 412 in the Electronic Content Asset on-screen viewing format assigned by the Subscriber or Publisher.
12. End-of-stream is reached, or the Subscriber issues a GUI-IPG request to stop viewing the subscription at step 413, perhaps by selecting a GUI-IPG STOP function or by tuning the set top box to cable TV programming.
13. GUI-IPG closes the streams at step 414 and may issue an API-Video Content Host Site request to indicate that viewing has terminated.
14. Electronic Content Asset Publication System software at step 415 may update the Publisher and Subscriber's access history for each request to view published content.

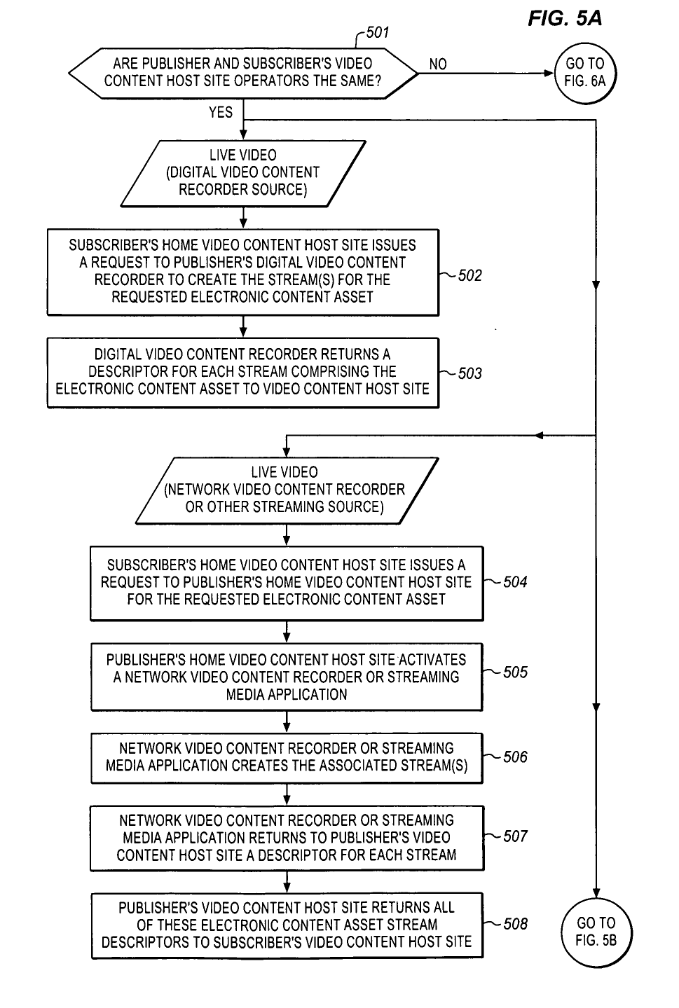

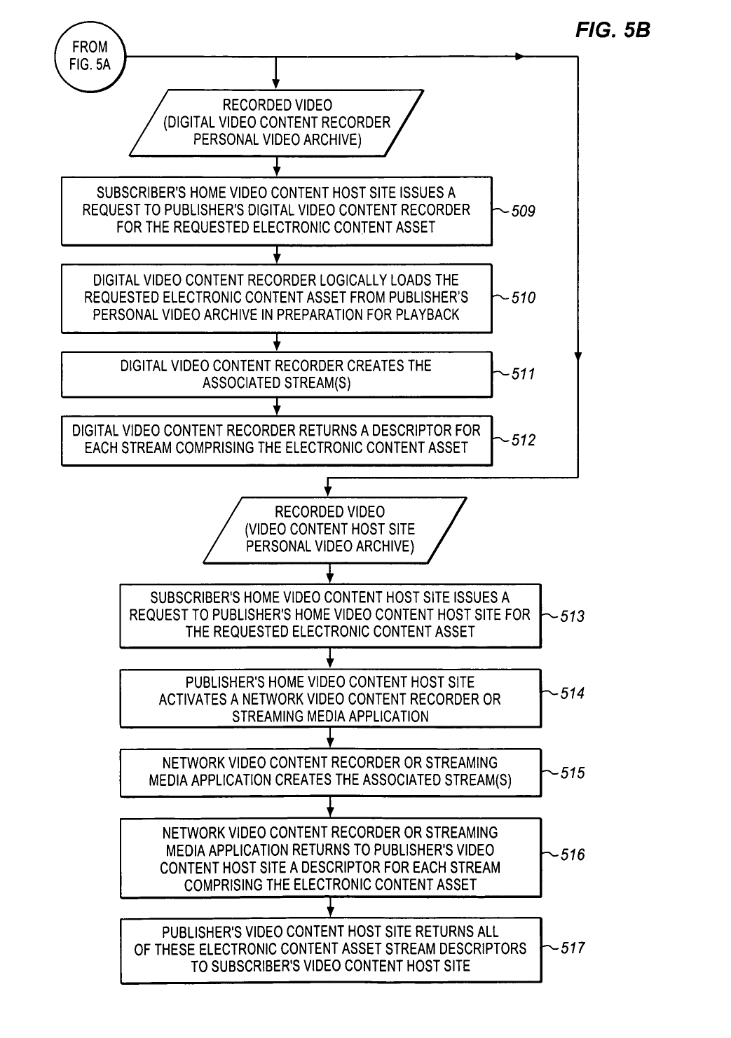

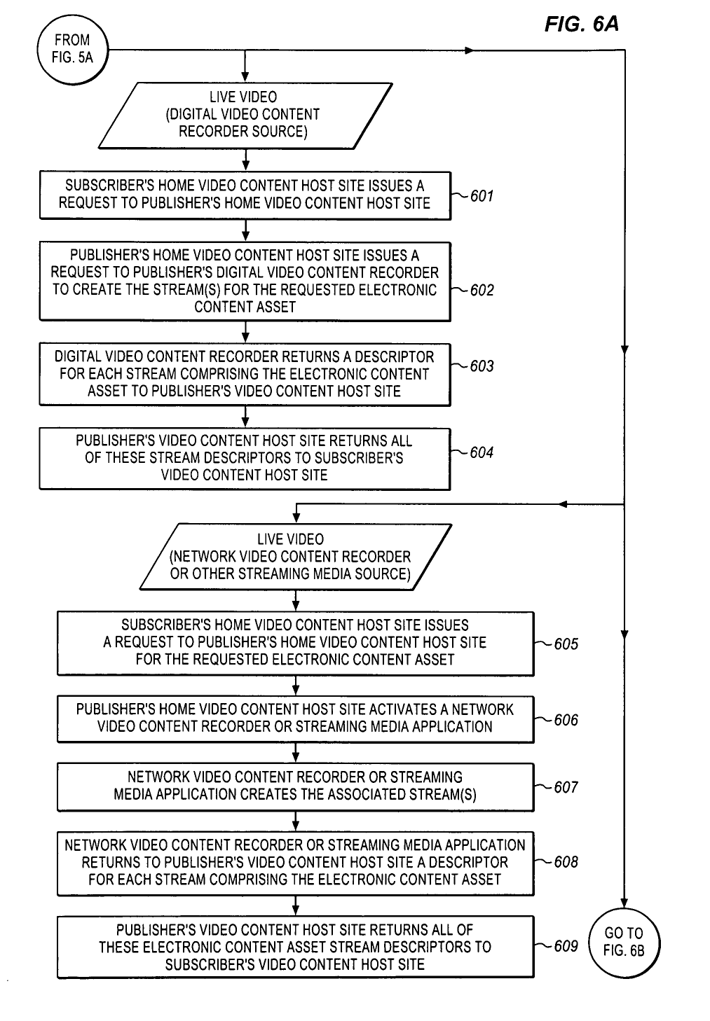

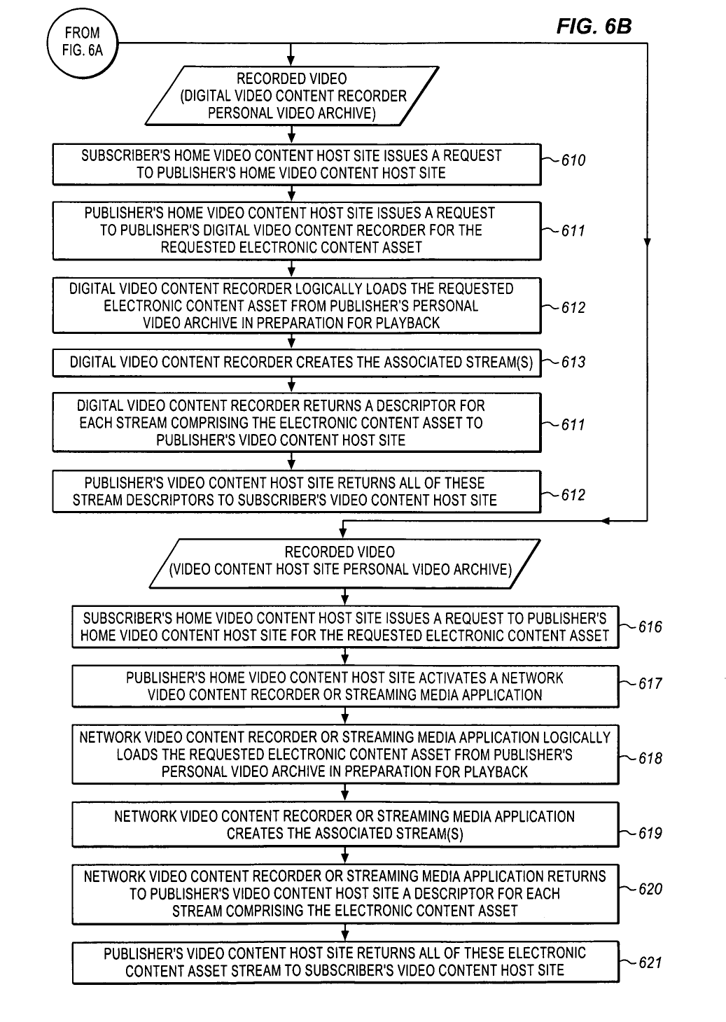

Which particular Electronic Content Asset Publication System APIs are used to create a stream for the requested Electronic Content Asset (step 409 above) depends on the subscription source as follows:
1. Publisher and Subscriber's Video Content Host Site operators are the same operator as determined at step 501 (FIGS. 5A and 5B):
   a. Live video (Digital Video Content Recorder source): Subscriber's Home Video Content Host Site issues a request, which may be an API-Digital Video Content Recorder request, at step 502 to Publisher's Digital Video Content Recorder to create the stream(s) for the requested Electronic Content Asset. Digital Video Content Recorder returns a descriptor at step 503 for each stream comprising the Electronic Content Asset to Video Content Host Site.
   b. Live video (Network Video Content Recorder source or other streaming media source): Subscriber's Home Video Content Host Site issues an API-Video Content Host Site request to Publisher's Home Video Content Host Site at step 504 for the requested Electronic Content Asset. Publisher's Home Video Content Host Site at step 505 activates a Network Video Content Recorder or streaming media application, which logically readies the requested Electronic Content Asset in preparation for streaming, then creates the associated stream(s) at step 506 and returns to Publisher's Video Content Host Site a descriptor for each stream comprising the Electronic Content Asset at step 507. Publisher's Video Content Host Site returns all of these Electronic Content Asset stream descriptors to Subscriber's Video Content Host Site at step 508.
   c. Recorded video (Digital Video Content Recorder Personal Video Archive): Subscriber's Home Video Content Host Site issues a request, which may be an API-Digital Video Content Recorder request, to Publisher's Digital Video Content Recorder at step 509 for the requested Electronic Content Asset. Digital Video Content Recorder logically loads the requested Electronic Content Asset at step 510 from Publisher's Personal Video Archive in preparation for playback, creates the associated stream(s) at step 511 and returns a descriptor for each stream comprising the Electronic Content Asset at step 512.
   d. Recorded video (Video Content Host Site Personal Video Archive): Subscriber's Home Video Content Host Site issues an API-Video Content Host Site request at step 513 to Publisher's Home Video Content Host Site for the requested Electronic Content Asset. Publisher's Home Video Content Host Site at step 514 activates a Network Video Content Recorder or streaming media application, which logically loads the requested Electronic Content Asset from Publisher's Personal Video Archive in preparation for playback, then creates the associated stream(s) at step 515 and returns to Publisher's Video Content Host Site at step 516 a descriptor for each stream comprising the Electronic Content Asset. Publisher's Video Content Host Site returns all of these Electronic Content Asset stream descriptors to Subscriber's Video Content Host Site at step 517.
2. Publisher and Subscriber's Video Content Host Site operators are two different operators as determined at step 501 on FIG. 5A:
   a. Live video (Digital Video Content Recorder source): Subscriber's Home Video Content Host Site at step 601 of FIG. 6A issues an API-Electronic Content Asset Gateway request to Publisher's Home Video Content Host Site, which issues a request, which may be an API-Digital Video Content Recorder request, at step 602 to Publisher's Digital Video Content Recorder to create the stream(s) for the requested Electronic Content Asset. Digital Video Content Recorder returns a descriptor at step 603 for each stream comprising the Electronic Content Asset to Publisher's Video Content Host Site, which returns all of these Electronic Content Asset stream descriptors to Subscriber's Video Content Host Site at step 604.
   b. Live video (Network Video Content Recorder source or other streaming media source): Subscriber's Home Video Content Host Site issues an API-Electronic Content Asset Gateway request at step 605 to Publisher's Home Video Content Host Site for the requested Electronic Content Asset. Publisher's Home Video Content Host Site at step 606 activates a Network Video Content Recorder or streaming media application, which logically readies the requested Electronic Content Asset in preparation for streaming, then creates the associated stream(s) at step 607 and returns to Publisher's Video Content Host Site a descriptor for each stream comprising the Electronic Content Asset at step 608. Publisher's Video Content Host Site returns all of these Electronic Content Asset stream descriptors to Subscriber's Video Content Host Site at step 609.
   c. Recorded video (Digital Video Content Recorder Personal Video Archive): Subscriber's Home Video Content Host Site issues an API-Electronic Content Asset Gateway request at step 610 to Publisher's Home Video Content Host Site, which issues a request, which may be an API-Digital Video Content Recorder request, at step 611 to Publisher's Digital Video Content Recorder for the requested Electronic Content Asset. Digital Video Content Recorder logically loads the requested Electronic Content Asset at step 612 from Publisher's Personal Video Archive in preparation for playback, creates the associated stream(s) at step 613 and returns a descriptor for each stream comprising the Electronic Content Asset to Publisher's Video Content Host Site at step 614, which returns all of these Electronic Content Asset stream descriptors to Subscriber's Video Content Host Site at step 615.
   d. Recorded video (Video Content Host Site Personal Video Archive): Subscriber's Home Video Content Host Site issues an API-Electronic Content Asset Gateway request at step 616 to Publisher's Home Video Content Host Site for the requested Electronic Content Asset. Publisher's Home Video Content Host Site activates a Network Video Content Recorder or streaming media application at step 617, which logically loads the requested Electronic Content Asset from Publisher's Personal Video Archive in preparation for playback at step 618, then creates the associated stream(s) at step 619 and returns to Publisher's Video Content Host Site a descriptor for each stream comprising the Electronic Content Asset at step 620. Publisher's Video Content Host Site returns all of these Electronic Content Asset stream descriptors to Subscriber's Video Content Host Site at step 621.

Cable operators may distribute Electronic Content Asset Metadata in much the same way, except a data-oriented protocol may be substituted for the streaming protocol. An operator may also use the present Electronic Content Asset Publication System basic cable access protocol, with minor variations, to share its Video On-Demand library with other operators as described herein. The basic cable access protocol is separate from the All-VoD Network cable access protocols, and all of these protocols may operate contemporaneously within the present Electronic Content Asset Publication System. A cable operator may combine multiple simultaneous streams comprising an Electronic Content Asset to reduce the number of streams that are delivered concurrently to the subscriber. When delivering an Electronic Content Asset that has been combined in such a fashion, the cable operator will notify the subscriber's GUI-IPG accordingly, whereupon GUI-IPG will adapt to process fewer streams for this Electronic Content Asset than the Publisher specified. To improve efficiencies when a cable operator has determined that a requesting subscriber is an Authorized Subscriber for an Electronic Content Asset held by another operator in the same federation, the cable operator may deliver that Electronic Content Asset to the Authorized Subscriber from an alternate source provided the operator can locate an identical copy of the requested Electronic Content Asset published elsewhere in the federation, one that it can deliver more efficiently than the subscriber-requested copy. For example, the operator may discover an identical copy of the requested Electronic Content Asset in its own Video On-Demand Library, which it can deliver to the Authorized Subscriber directly without using the Electronic Content Asset Gateway. Other such efficiency improvements are possible.

While a cable network implementation for the streaming delivery of Electronic Content Assets has been described, it is evident that these above-described architectures, processes and APIs can be readily extended to any other communication medium, delivery method or asset format.

### SUMMARY

The Electronic Content Asset Publication System operates as an overlay application on the native multi-media communication network to receive individual subscriber requests for a selected Electronic Content Asset and deliver that asset to the requesting subscriber. This system acquires, stores, publishes, distributes, accesses and processes Electronic Content Assets on demand and delivers these assets in the format of the subscriber's communication medium and multi-media device over a selected multi-media communications infrastructure. This system provides access to specific subscriber-initiated Electronic Content Assets that are of interest to the subscriber. The Electronic Content Assets comprise individual multi-media streams, multi-media files or streams of multi-media files, initiated and published by individual subscribers rather than the mass media distributed by conventional content sources.

What is claimed as new and desired to be protected by Letters Patent of the United States is:

1. A system, operable in a communication network, for providing electronic content on demand to selected subscribers, comprising:
publishing means for storing a plurality of electronic content assets, which are originated by an individual, in a location which is accessible by at least one authorized subscriber;
personal electronic content asset management means for enabling said individual to manage said stored plurality of electronic content assets comprising:
publisher/subscriber database means for storing for storing Electronic Content Asset Publication Metadata, received from said individual and comprising at least one of title, storage location, authorized subscriber list and source data relating to said electronic content asset for use by search engines or applications;
content request means, responsive to a subscriber requesting access to said electronic content asset, for determining whether said requesting subscriber is one of said at least one subscriber specified by said originator of said electronic content asset;
medium means for determining a medium on which to transmit said requested electronic content asset to said requesting subscriber; and
delivery means for transmitting said requested electronic content asset to said requesting subscriber on said determined medium.

2. The system for providing electronic content on demand of claim 1 wherein said personal electronic content asset management means comprises:
subscription means for storing data that defines a one-to-many subscription relationship to limit access to each of said stored plurality of electronic content assets to a specified authorized subscriber base.

3. The system for providing electronic content on demand of claim 1 wherein said personal electronic content asset management means comprises:
electronic content asset characterization means for storing Electronic Content Asset Publication Metadata, received from said individual and comprising at least one of tide, classification, source and index data relating to said electronic content asset for use by search engines or applications.

4. The system for providing electronic content on demand of claim 1 wherein said personal electronic content asset management means comprises:
publication rules means for storing data received from an originator of said electronic content asset which defines a set of electronic content asset publication rules.

5. The system for providing electronic content on demand of claim 4 wherein said electronic content asset publication rules comprise: authorized subscribers, content availability schedules, allowable mediums for publication, allowable device types, authorized destinations, content storage management, expiration date of electronic content asset, and asset composition and layout.

6. The system for providing electronic content on demand of claim 4 wherein said personal electronic content asset management means further comprises:
publication terms-of-use means for storing data indicative of a set of subscriber access rights including at least one of: re-publication rights, scheduled availability, medium access rights, and device access rights.

7. The system for providing electronic content on demand of claim 4 wherein said personal electronic content asset management means further comprises:
re-publication means for defining rights of an authorized subscriber to re-publish an electronic content asset to other authorized subscribers.

8. The system for providing electronic content on demand of claim 4 wherein said personal electronic content asset management means further comprises:
schedule means for controlling when a specified electronic content asset may be accessed, including but not limited to start date/time and duration, expiration date/time, recurrence frequency.

9. The system for providing electronic content on demand of claim 4 wherein said personal electronic content asset management means further comprises:
medium access means for defining the multi-media communication medium from which a published electronic content asset may be accessed.

10. The system for providing electronic content on demand of claim 4 wherein said personal electronic content asset management means further comprises:
device access means for defining the multi-media device from which a published electronic content asset may be viewed.

11. The system for providing electronic content on demand of claim 4 wherein said personal electronic content asset management means further comprises:
revocation means for enabling said individual to selectively revoke subscription rights to a selected electronic content asset at any time.

12. The system for providing electronic content on demand of claim 4 wherein said personal electronic content asset management means further comprises:
unsubscription means for enabling an authorized subscriber to unsubscribe from an electronic content asset.

13. The system for providing electronic content on demand of claim 4 wherein said personal electronic content asset management means further comprises:
private re-publication means for limiting electronic content asset access to the authorized subscribers who are assigned subscription rights firsthand by the individual.

14. The system for providing electronic content on demand of claim 4 wherein said personal electronic content asset management means further comprises:
semi-private re-publication means for limiting electronic content asset re-publication capabilities.

15. The system for providing electronic content on demand of claim 4 wherein said personal electronic content asset management means further comprises:
public republication means for granting access to an electronic content asset to every subscriber.

16. A method, operable in a communication network, of providing electronic content on demand to selected subscribers, comprising:
publishing a plurality of electronic content assets, which are originated by an individual, in a location which is accessible by at least one authorized subscriber;
enabling said individual to manage said stored plurality of electronic content assets comprising:
storing Electronic Content Asset Publication Metadata, received from said individual and comprising at least one of tide, storage location, authorized subscriber list and source data relating to said electronic content asset for use by search engines or applications;
determining, in response to a subscriber requesting access to said electronic content asset, whether said requesting subscriber is one of said at least one subscriber specified by said originator of said electronic content asset;
identifying a medium on which to transmit said requested electronic content asset to said requesting subscriber; and
transmitting said requested electronic content asset to said requesting subscriber on a determined medium.

17. The method of providing electronic content on demand of claim 16 wherein said step of enabling comprises:
storing subscription data that defines a one-to-many subscription relationship to limit access to each of said stored plurality of electronic content assets to a specified authorized subscriber base.

18. The method of providing electronic content on demand of claim 16 wherein said step of enabling comprises:
storing Electronic Content Asset Publication Metadata, received from said individual and comprising at least one of title, classification, source and index data relating to said electronic content asset for use by search engines or applications.

19. The method of providing electronic content on demand of claim 16 wherein said step of enabling comprises:
storing publication rules data received from an originator of said electronic content asset which defines a set of electronic content asset publication rules.

20. The method of providing electronic content on demand of claim 19 wherein said publication rules comprise: authorized subscribers, content availability schedules, allowable mediums for publication, allowable device types, authorized destinations, content storage management, expiration date of electronic content asset, and asset composition and layout.

21. The method of providing electronic content on demand of claim 19 wherein said step of enabling further comprises:
storing publication rules of use data indicative of a set of subscriber access rights including at least one of: republication rights, scheduled availability, medium access rights, and device access rights.

22. The method of providing electronic content on demand of claim 19 wherein said step of enabling further comprises:
defining rights of an authorized subscriber to re-publish an electronic content asset to other authorized subscribers.

23. The method of providing electronic content on demand of claim 19 wherein said step of enabling further comprises:
controlling when a specified electronic content asset may be accessed, including but not limited to start date/time and duration, expiration date/time, recurrence frequency.

24. The method of providing electronic content on demand of claim 19 wherein said step of enabling comprises:
defining the multi-media communication medium from which a published electronic content asset may be accessed.

25. The method of providing electronic content on demand of claim 19 wherein said step of enabling further comprises:
defining the multi-media device from which a published electronic content asset may be viewed.

26. The method of providing electronic content on demand of claim 19 wherein said step of enabling further comprises:
enabling said individual to selectively revoke subscription rights to a selected electronic content asset at any time.

27. The method of providing electronic content on demand of claim 19 wherein said step of enabling further comprises:
enabling an authorized subscriber to unsubscribe from an electronic content asset.

28. The method of providing electronic content on demand of claim 19 wherein said step of enabling further comprises:
limiting electronic content asset access to the authorized subscribers who are assigned subscription rights firsthand by the individual.

29. The method of providing electronic content on demand of claim 19 wherein said step of enabling further comprises:
limiting electronic content asset re-publication capabilities.

30. The method of providing electronic content on demand of claim 19 wherein said step of enabling further comprises:
granting access to an electronic content asset to every subscriber.
